(19) United States
(12) Patent Application Publication
(10) Pub. No.: US 2010/0270343 A1
(43) Pub. Date: Oct. 28, 2010

(54) Apparatus for knife sheath lock

(76) Inventor: Frank E. Clark, Kalispell, MT (US)

Correspondence Address: MCKENNA LONG & ALDRIDGE LLP, 1900 K STREET, NW, WASHINGTON, DC, 20006, US

(21) Appl. No.: 12/453,001

(22) Filed: Apr. 27, 2009

(51) Int. Cl. B26B 29/02; E05B 73/00

(52) U.S. Cl. 224/232; 224/242; 70/58

(57) ABSTRACT

This is knife sheath combination lock assembly configured to minimize foreign elements from interfering with the operation of the lock assembly. The lock assembly can be used for both fixed blade knives and foldable knives. The locking mechanism for securing the knife to the sheath, the locking mechanism including; a lock assembly, and a spring attached to the lock assembly, wherein when the knife is inserted into the sheath, the lock assembly secures the knife; and wherein the spring has a first spring area distal a second spring area, the second spring area adjacent the lock assembly, and the first spring area adjacent the sheath.

### BACKGROUND OF THE INVENTION

1. Field of the Invention

The present invention relates to a locking assembly used to secure a fixed blade knife and folding knife within a sheath.

2. Discussion of the Related Art

Some knives are used in the harshest of environments. For example, when they are used in the outdoors as hunting knifes, knives and their sheaths are exposed to the elements of the environment. Some of these elements include dirt, grit, twigs, ice, and water. These elements can prevent a knife from being properly stored within its sheath. Conventional lock assemblies can become unworkable when an element such as water enters the locking assembly and freezes or when dirt enters the locking assembly. Additionally, conventional locking mechanisms such as Velcro or snapping straps that are used to secure the knife to the sheath are prone to snagging and as such may be inadvertently opened by snagging. Also conventional locking mechanisms may not be physically shielded by the knife and or sheath making the locking mechanisms vulnerable to inadvertent openings. Once inadvertently opened these conventional locking mechanisms have no way of automatically closing to secure the knife to the sheath again. Making conventional locking assemblies unreliable.

Also, conventional locking assemblies require the use of two hands and a visual confirmation that the knife has been secured within its sheath, making them difficult to operate.

Furthermore, conventional locking assemblies are also easily bypassed by applying excessive force to the handle of the knife when extracting the knife from its sheath, making conventional locking assemblies unsafe and unreliable.

In addition to the problems of conventional locking assemblies mentioned above, not all knives are the same size and shape. Hence, versatility is also desirable in designing a locking assembly for knives. With versatility in a locking assembly, the knife itself will not have to be modified to be securable with a sheath. Conventional locking assemblies generally will only work with one type of knife or one specific knife for a specific sheath. This increases costs to a customer because only one type of knife can work with one type of locking assembly. Therefore, there is a need to create a locking assembly that is reliable, easily operable, and versatile, and not easily bypassed, yet inexpensive to manufacture.

### SUMMARY OF THE INVENTION

Moreover, an advantage of the present invention is that the present invention's locking assembly is intended to be a simple design with minimal elements, making the locking assembly very inexpensive to manufacture as well. The simple design of the locking assembly is also considered aesthetically pleasing as the only visible part of the system is the button, which can be configured in any manner to compliment the design-look of the knife and sheath.

Accordingly, the present invention is directed to a sheath locking assembly that substantially obviates one or more of the problems due to limitations and disadvantages of the related art.

An advantage of the present invention is to provide a locking mechanism for securing a knife to a sheath, the locking mechanism comprising: a lock assembly, and a spring attached to the lock assembly, wherein when the knife is inserted into the sheath, the lock assembly secures the knife; and wherein the spring has a first spring area distal a second spring area, the second spring area adjacent the lock assembly, and the first spring area adjacent the sheath.

Another advantage of the present invention is to provide a sheath for use with a knife, comprising: a main portion, a receptacle extending from the main portion, a lock assembly spaced from an opening of the receptacle, a spring operably connecting the lock assembly to the main portion, wherein the spring has a first spring area and a second spring area, the first spring area operably connected to the sheath, and the second spring area adjacent the lock assembly; and wherein the lock assembly is capable of engaging a portion of the knife.

In another aspect of the present invention, a sheath for use with a knife, comprises a main portion having a front side and a back side, a receptacle area extending from the main portion, an opening through the main portion extending between the front side and the back side, a lock assembly spaced from an opening of the receptacle, the lock assembly having a first end workably attached to the main portion, the lock assembly having a second end engagable to the opening in the main portion, a flange attached to the first end of the lock assembly, the back side substantially preventing the flange from engaging the opening in the main portion, an assembly magnet adjacent to the lock assembly, and a recessed sheath portion attached to the backside of the main portion.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates a front view of a leaf spring and lock assembly having a rivet.

FIG. 2 illustrates a back view of a leaf spring and lock assembly having a rivet.

FIG. 3 illustrates a side view of a leaf spring and lock assembly having a rivet.

FIG. 4 illustrates a front view of a leaf spring and lock assembly having a rivet for a foldable knife.

FIG. 5 illustrates a side view of a leaf spring and lock assembly having a rivet for a foldable knife.

FIG. 6 illustrates a front view of a leaf spring and lock assembly having a rivet below the hilt.

FIG. 7 illustrates a back view of a leaf spring and lock assembly having a rivet below the hilt.

FIG. 8 illustrates a side view of a leaf spring and lock assembly having a rivet below the hilt.

FIG. 9 illustrates a front view of a leaf spring and lock assembly having a rivet below the hilt for a foldable knife.

FIG. 10 illustrates a side view of a leaf spring and lock assembly having a rivet below the hilt for a foldable knife.

FIG. 11 illustrates a front view of a lock spring and lock assembly.

FIG. 12 illustrates a side view of a lock spring and lock assembly.

FIG. 13 illustrates a front view of a lock spring and lock assembly for a foldable knife.

FIG. 14 illustrates a side view of a lock spring and lock assembly for a foldable knife.

FIG. 15 illustrates a front view of a coil spring and lock assembly.

FIG. 16 illustrates a side view of a coil spring and lock assembly.

FIG. 17 illustrates a front view of a coil spring and lock assembly for a foldable knife.

FIG. 18 illustrates a side view of a coil spring and lock assembly for a foldable knife.

FIG. 19 illustrates a front view of a foam spring and lock assembly.

FIG. 20 illustrates a side view of a foam spring and lock assembly.

FIG. 21 illustrates a front view of a foam spring and lock assembly for a foldable knife.

FIG. 22 illustrates a side view of a foam spring and lock assembly for a foldable knife.

FIG. 23 illustrates a front view of a lock assembly having an assembly magnet and a recessed main portion magnet.

FIG. 24 illustrates a side view of a lock assembly having an assembly magnet and a recessed main portion magnet.

FIG. 25 illustrates a front view of a lock assembly having an assembly magnet and a recessed main portion magnet for a foldable knife.

FIG. 26 illustrates a side view of a lock assembly having an assembly magnet and a recessed main portion magnet for a foldable knife.

FIG. 27 illustrates a front view of a lock assembly having a bent leaf spring.

FIG. 28 illustrates a side view of a lock assembly having a bent leaf spring.

FIG. 29 illustrates a front view of a lock assembly having a bent leaf spring for a foldable knife.

FIG. 30 illustrates a side view of a lock assembly having a bent leaf spring for a foldable knife.

FIG. 31 illustrates a front view of a lock assembly having a safety pin type spring.

FIG. 32 illustrates a side view of a lock assembly having a safety pin type spring.

FIG. 33 illustrates a front view of a lock assembly having a safety pin type spring for a foldable knife.

FIG. 34 illustrates a side view of a lock assembly having a safety pin type spring for a foldable knife.

FIG. 35 illustrates a front view of a lock assembly having a gas strut.

FIG. 36 illustrates a side view of a lock assembly having a gas strut.

FIG. 37 illustrates a front view of a lock assembly having a gas strut for a foldable knife.

FIG. 38 illustrates a side view of a lock assembly having a gas strut for a foldable knife.

FIG. 39 illustrates a front view of a lock assembly having a metal plate and a magnet.

FIG. 40 illustrates a side view of a lock assembly having a metal plate and a magnet.

FIG. 41 illustrates a front view of a lock assembly having a metal plate and a magnet for a foldable knife.

FIG. 42 illustrates a side view of a lock assembly having a metal plate and a magnet for a foldable knife.

### DETAILED DESCRIPTION OF THE ILLUSTRATED EMBODIMENTS

Reference will now be made in detail to embodiments of the present invention, examples of which are illustrated in the accompanying drawings.

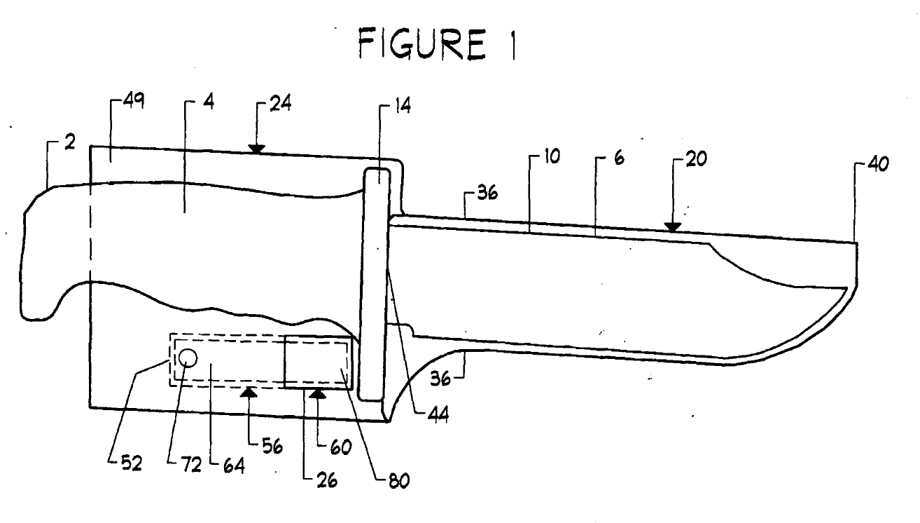

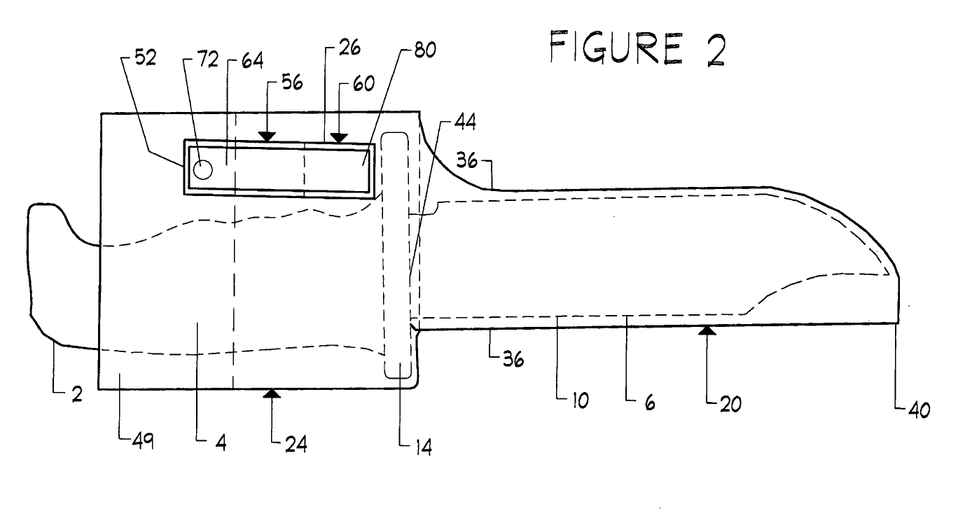

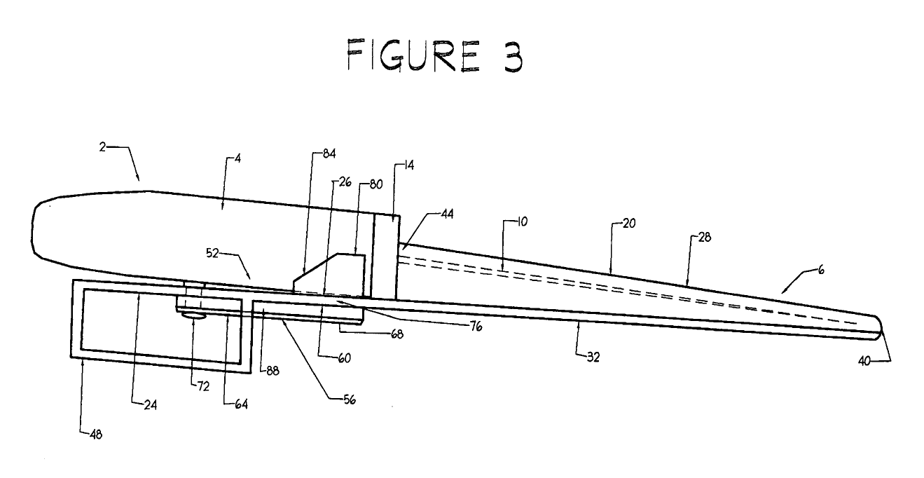

FIGS. 1-3 illustrate the first exemplary embodiment, which includes a fixed blade knife 2 and a knife sheath 6. The fixed blade knife 2 includes a blade 10 and a handle 4 extending from the blade 10. Between the blade 10 and the handle 4 is a hilt 14. A sheath 6 is generally used for holding a knife. When the fixed blade knife 2 is not in use, it may be held within the sheath 6 for safe storage. In the first exemplary embodiment the knife sheath 6 includes a knife receptacle 20 in which a knife is received. The knife sheath 6 may also have a main portion 24 which can be attached to the knife receptacle 20. Additionally, the main portion 24 may be used to attach the knife receptacle 20 to the belt of a user who may be using the knife and knife sheath. Though not illustrated in any of the figures the main portion 24 may also be removable as well as attachable by any known means in the art to substantially any receptacle 20. Referring to FIG. 3, in the present embodiment, the knife receptacle 20 of the knife sheath 6 is an elongated, hollow structure with a front receptacle side 28, an oppositely disposed back side 32, two oppositely disposed narrow edges 36, a generally closed lower end 40, and an open upper end 44 through which the knife is received for storage. At the upper end 44 of the back side 32 of the knife sheath 6, the main portion 24 starts at the upper end 44 and extends upwardly parallel to the direction of elongation of the sheath 6. A belt loop 48 may be provided at the upper back side end of the main portion 24. For reference, oppositely disposed to the back side 32 of the main portion 24 is a front side 49.

The locking mechanism 52 of the present embodiment is intended for use with a fixed blade knife for securing the fixed blade knife 2 to the sheath 6 while the blade 10 is positioned inside the receptacle 20 of the sheath 6. The locking mechanism 52 is generally illustrated in FIGS. 1-3, and may include a leaf spring 56 and lock assembly 60. More specifically, the locking mechanism 52 in the first exemplary embodiment includes a leaf spring 56 having a first spring area 64 and a second spring area 68. The first spring area 64 and the second spring area 68 may be opposite ends of a single leaf spring 56. The first spring area 64 may be attached to the backside 28 of the main portion 24. In one example, the first spring area 64 is attached to the main portion 24 by a rivet 72. The first spring area 64 can also be attached to the main portion 24 by a pivot hinge (not shown) or any other means of attaching known in the art. The second spring area 68 may be attached to the lock assembly 60.

FIG. 3 provides a side view of the locking mechanism 52 according to the first exemplary embodiment. The lock assembly 60 may have a substantially cube like shape having a first assembly end 76 attached to the second spring area 68, and having a second assembly end 80 protruding through the back side 32 of the main portion 24 and over the hilt 14 of the fixed blade knife 2. The cubical corner of the second assembly end 80 that is furthest away from the knife receptacle 20 can be rounded to create a rounded corner 84, as illustrated in FIG. 3. The alignment of the leaf spring 56 can be parallel to the back side 32 of the main portion 24. The leaf spring 56 can also be covered by a spacer 88 to distance the space between the first spring area 64 and the back side 32 of the main portion 24. The spacer 88 can also be used to create distance between the second spring area 68 and the first assembly end 76. As one of skill in the art will appreciate, the shape of the lock assembly may be any shape consistent with the teaching of this disclosure.

According to the first exemplary embodiment, when the blade 10 of the fixed blade knife 2 is inserted into the knife receptacle 20, the fixed blade knife 2 is substantially automatically locked to the sheath 6 by the locking mechanism 52. The rounded corner 84 of the lock assembly 60 may allow the hilt 14 and blade 10 to more easily pass over the lock assembly 60 with little resistance when the fixed blade knife 2 is inserted into the knife receptacle 20. As the hilt 14 or blade 10 passes over the lock assembly 60, the lock assembly 60 may be depressed with minimal resistance from the leaf spring 56 through an opening 26 in the main portion 24 of the back side 32. Once the hilt 14 passes over the lock assembly 60, the lock assembly 60 springs back to its resting position through the opening 26 in the main portion 24 and back over and above the hilt 14, thus substantially automatically securing the fixed blade knife 2 to the sheath 6. A resting position of the lock assembly 60 is illustrated in FIGS. 1, 2, and 3. In addition to the automatic securing of the knife, the user of the fixed blade knife 2 may also depress the lock assembly 60 through the opening 26 in the main portion 24 to allow the hilt 14 to pass over the lock assembly 60. The user may then release the lock assembly 60 to lock the fixed blade knife 2 to the sheath 6. In the lock assembly's resting position, the hilt 14 is secured between the lock assembly 60 and the upper end 44 of the knife receptacle 20 to substantially secure the fixed blade knife 2 to the sheath 6.

When removing the fixed blade knife 2 from the receptacle 20, the second assembly end 80 of the lock assembly 60 may first clear the hilt's 14 path. To clear the hilt's 14 path, the lock assembly 60 may be depressed through the opening 26 in the main portion 24 clearing the path of the hilt 14 before pulling the blade 10 from the knife receptacle 20. If the lock assembly 60 is not depressed before trying to remove the fixed blade knife 2 from the knife receptacle 20, the hilt 14 will make contact with the lock assembly 60. This contact will substantially prevent the removal of the fixed blade knife 2. More specifically, when the fixed blade knife 2 is pulled toward the lock assembly 60, downward forces are created by the leaf spring 56 to substantially prevent the hilt 14 from bypassing the lock assembly 60 by mere pulling on the fixed blade knife 2. Furthermore, these downward forces increase as the pulling forces to remove the fixed blade knife 2 increase.

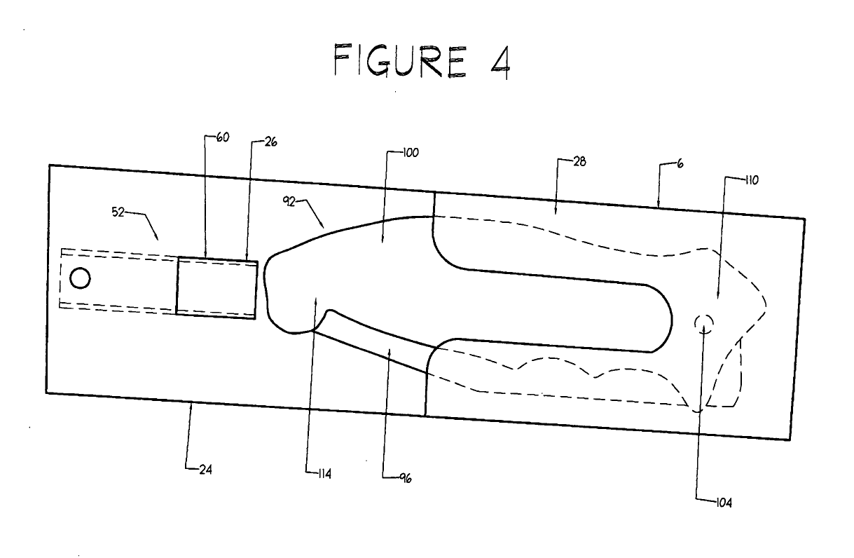

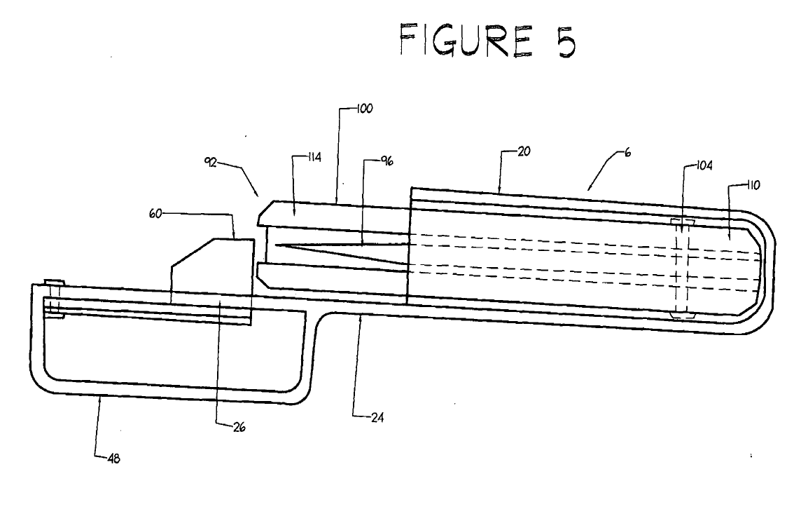

FIGS. 4 and 5 further illustrate the first exemplary embodiment, wherein the embodiment is being used in conjunction with a foldable knife 92. The foldable knife 92 may consist of a blade 96 and a handle 100 extending from the blade 96. A folding point 104 may be located at a first handle end 110 to allow the blade 96 to substantially fold into the handle 100. The blade 96 may be folded into the handle 100 to be in a folded position, as illustrated.

In this example, opposite the first handle end 110 is a second handle end 114. To secure the foldable knife 92 within the sheath 6, the foldable knife 92 is first folded. Next, the foldable knife 92 is inserted into the knife receptacle 20 such that the lock assembly 60 may engage the second handle end 114. To remove the foldable knife 92 from the sheath 6, the lock assembly 60 may be depressed through the opening 26 in the main portion 24 to substantially clear the lock assembly 60 from the path of the second handle end 114. Then the foldable knife 92 can then be removed from the sheath 6.

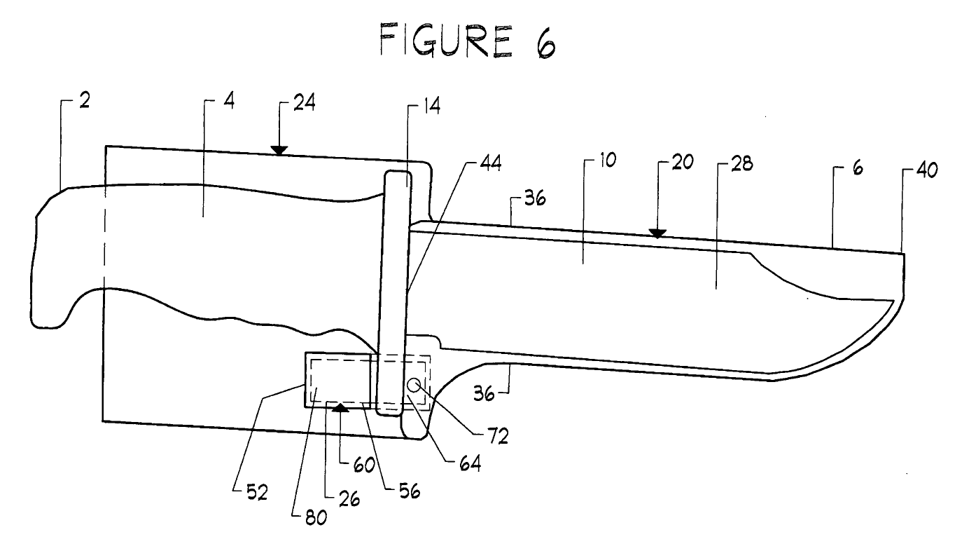

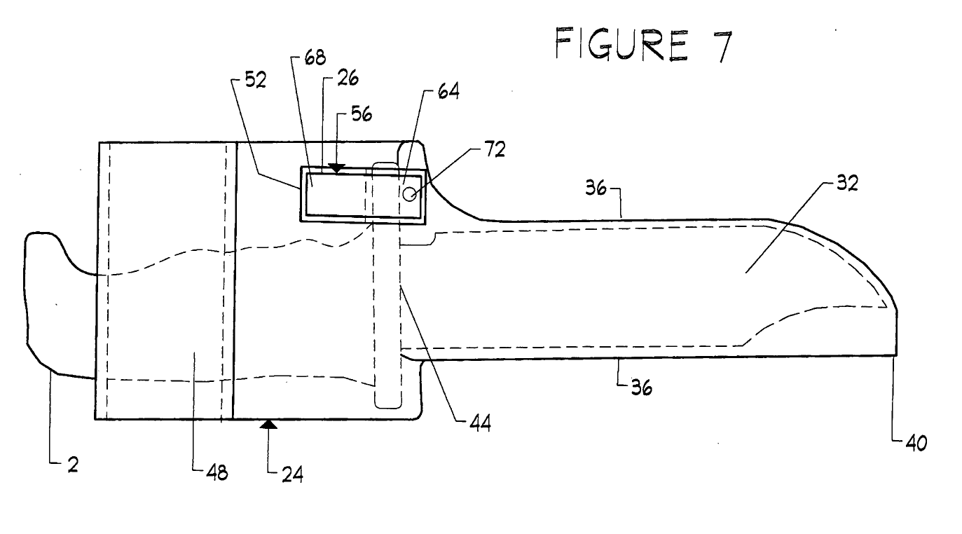

FIGS. 6-7 illustrate a second exemplary embodiment of the locking mechanism 52. For brevity, detailed descriptions of the knife and sheath will not be repeated. The locking mechanism 52 of FIGS. 6-7 may include a leaf spring 56 and lock assembly 60. More specifically, the leaf spring 56 may have a first spring area 64 and a second spring area 68. The first spring area 64 and the second spring area 68 may be opposite ends of a single leaf spring 56. In this exemplary embodiment the first spring area 64 may be attached to the back side 32 of the knife receptacle 20. In one example, the first spring area 64 is attached to the back side 32 by a rivet 72. The first spring area 64 can also be attached to the back side 32 by any other means of attaching known in the art. The second spring area 68 may be attached to the lock assembly 60.

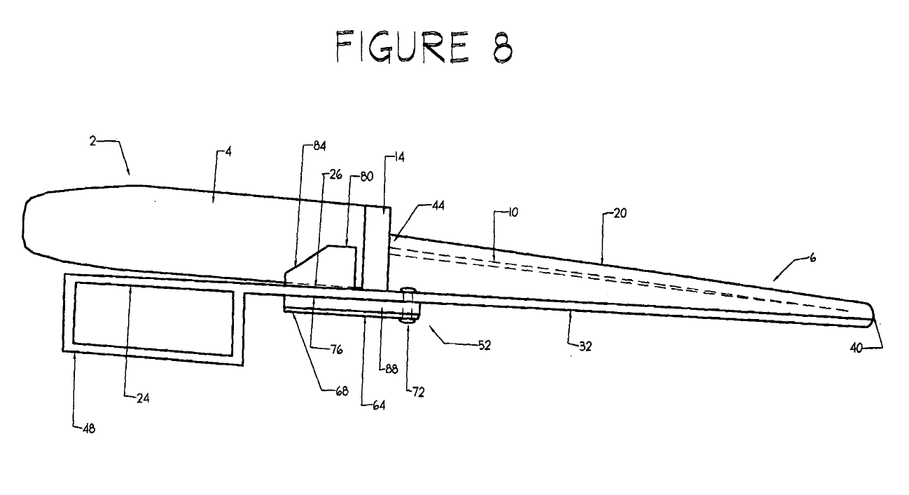

FIG. 8 provides a side view of the locking mechanism 52 according to the second exemplary embodiment. The lock assembly 60 may have a substantially cube like shape having a first assembly end 76 attached to the second spring area 68, and having a second assembly end 80 protruding through the back side 32 of the main portion 24 and over the hilt 14 of the fixed blade knife 2. The cubical corner of the second assembly end 80 that is furthest away from the knife receptacle 20 can be rounded to create a rounded corner 84, as illustrated in FIG. 8. The alignment of the leaf spring 56 can be parallel to both the back side 32 of the knife receptacle 20 and the back side 32 of the main portion 24. The leaf spring 56 can also be covered by a spacer 88 to distance the space between the first spring area 64 and both the back side 32 of the knife receptacle 20 and back side 32 of the main portion 24. The spacer 88 can also be used to create distance between the second spring area 68 and the first assembly end 92. As one of skill in the art will appreciate, the shape of the lock assembly may be any shape consistent with the teaching of this disclosure.

According to the second exemplary embodiment, when the blade 10 of the fixed blade knife 2 is inserted into the knife receptacle 20, the fixed blade knife 2 is substantially automatically locked to the sheath 6 by the locking mechanism 52. The rounded corner 84 of the lock assembly 60 will allow the hilt 14 and blade 10 to more easily pass over the lock assembly 60 with little resistance when the fixed blade knife 2 is inserted into the knife receptacle 20. As the hilt 14 or blade 10 passes over the lock assembly 60, the lock assembly 60 is depressed with minimal resistance from the leaf spring 56 through an opening 26 in the main portion 24 of the back side 32. Once the hilt 14 passes over the lock assembly 60, the lock assembly 60 springs back substantially to its resting position through the opening 26 in the main portion 24 and back over and above the hilt 14, thus substantially automatically securing the fixed blade knife 2 to the sheath 6. A resting position of the lock assembly 60 is illustrated in FIGS. 6-8. In addition to the automatic securing of the knife, the user of the fixed blade knife 2 may also depress the lock assembly 60 through the opening 26 in the main portion 24 to allow the hilt 14 to pass over the lock assembly 60. The user may then release the lock assembly 60 to lock the fixed blade knife 2 to the sheath 6. In the lock assembly's resting position, the hilt 14 is substantially secured between the lock assembly 60 and the upper end 44 of the knife receptacle 20 to substantially secure the fixed blade knife 2 to the sheath 6.

When removing the fixed blade knife 2 from the receptacle 20, the second assembly end 80 of the lock assembly 60 should first clear the hilt's 14 path. To clear the hilt's 14 path, the lock assembly 60 may be depressed through the opening 26 in the main portion 24 clearing the path of the hilt 14 before pulling the blade 10 from the knife receptacle 20. If the lock assembly 60 is not depressed before trying to remove the fixed blade knife 2 from the knife receptacle 20, the hilt 14 will make contact with the lock assembly 60. This contact will substantially prevent the removal of the fixed blade knife 2. More specifically, when the fixed blade knife 2 is pulled toward the lock assembly 60, the hilt 14 substantially abuts the end of the lock assembly 60 that is located substantially adjacent to the rivet 72 to substantially prevent the hilt 14 from bypassing the lock assembly 60 by mere pulling on the fixed blade knife 2.

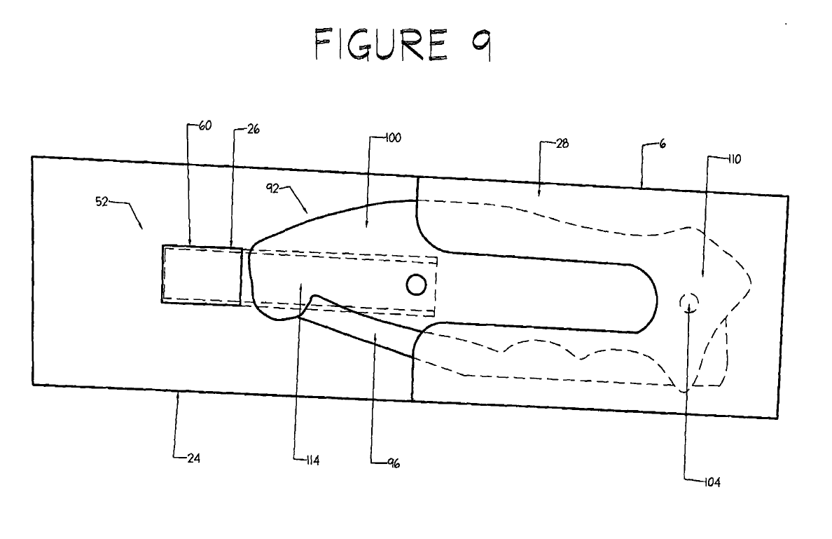

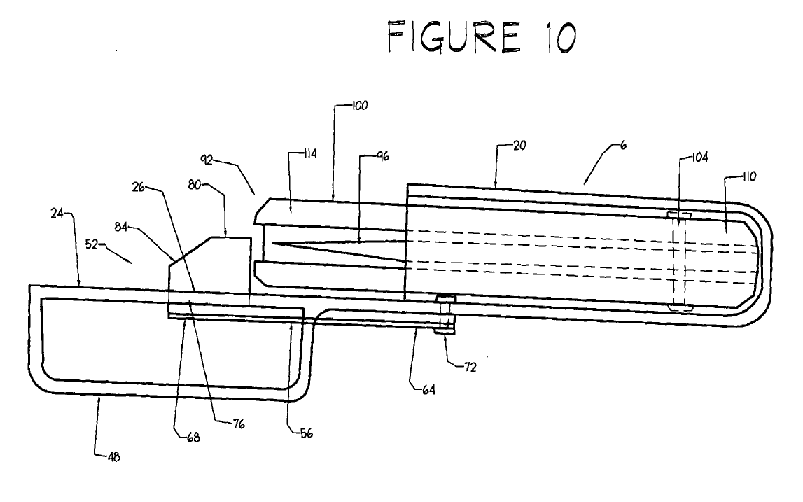

FIGS. 9 and 10 further illustrate the second exemplary embodiment, wherein the embodiment is being used in conjunction with a foldable knife 92. The foldable knife 92 may consist of a blade 96 and a handle 100 extending from the blade 96. A folding point 104 may be located at a first handle end 110 to allow the blade 96 to substantially fold into the handle 100. When the blade 96 is folded into the handle 100, the foldable knife 92 may be in a folded position, as illustrated.

In this example, opposite the first handle end 110 is a second handle end 114. To secure the foldable knife 92 within the sheath 6, the foldable knife 92 is first folded. Next, the foldable knife 92 is inserted into the knife receptacle 20 such that the lock assembly 60 may engage the second handle end 114. To remove the foldable knife 92 from the sheath 6, the lock assembly 60 may be depressed through the opening 26 in the main portion 24 to substantially clear the lock assembly 60 from the path of the second handle end 114. Then the foldable knife 92 can then be removed from the sheath 6.

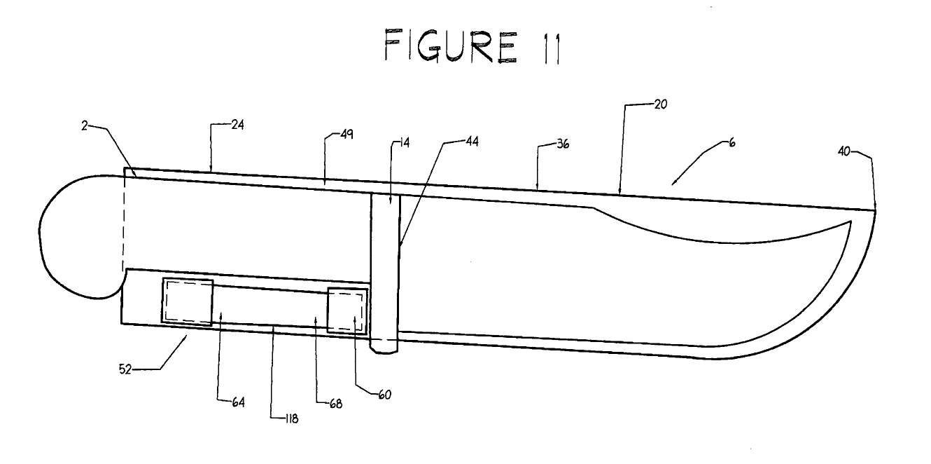

FIG. 11 illustrates a third exemplary embodiment of the locking mechanism 52. For brevity, detailed descriptions of the knife and sheath will not be repeated. The locking mechanism 52 of FIG. 11 may include a lock spring 118 and lock assembly 60. More specifically, the lock spring 118 may have a first spring area 64 and a second spring area 68. The first spring area 64 and the second spring area 68 may be opposite ends of a single lock spring 118. In this exemplary embodiment the first spring area 64 may be attached to the front side 49 of the main portion 24. The first spring area 64 can be attached to the front side 49 by a rivet (not shown) or any other means of attaching known in the art. The second spring area 68 may be attached to the lock assembly 60.

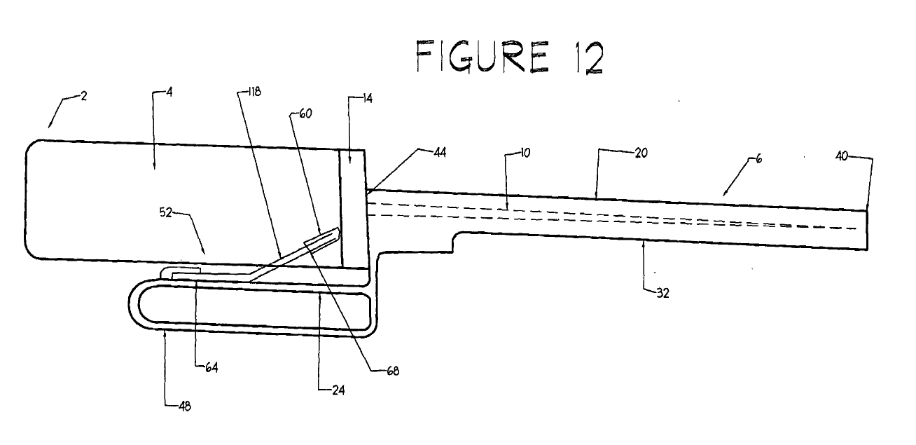

FIG. 12 provides a side view of the locking mechanism 52 according to the third exemplary embodiment. The lock assembly 60 may be attached to the distal end of the second spring area 68, forming a substantially cubical structure around the second spring area 68 of the spring as illustrated in FIG. 12. The second spring area 68 along with the lock assembly 60 may substantially protrude over the hilt 14 of the fixed blade knife 2. As one of skill in the art will appreciate, the shape of the lock assembly may be any shape consistent with the teaching of this disclosure.

According to the third exemplary embodiment, when the blade 10 of the fixed blade knife 2 is inserted into the knife receptacle 20, the fixed blade knife 2 is substantially automatically locked to the sheath 6 by the locking mechanism 52. The lock assembly 60 may be closely formed around the second spring area 68 to substantially minimize the differences in the widths of the locking assembly and second spring area. The lock assembly 60 may also be attached substantially adjacent the second spring area 68. However, the reduced difference in widths of the spring and locking assembly 60 can reduce the offset between the locking assembly 60 and the lock spring 118, allowing the hilt 14 and blade 10 to more easily pass over the lock assembly 60 and lock spring 118, with substantially little resistance when the fixed blade knife 2 is inserted into the knife receptacle 20. As the hilt 14 or blade 10 passes over the lock assembly 60, the lock assembly 60 is depressed with minimal resistance from the lock spring 118 substantially towards the front side 49 of the main portion 24. Once the hilt 14 passes over the lock assembly 60, the lock assembly 60 springs back to its resting position away from the front side 49 of the main portion 24 and back over and above the hilt 14, thus substantially automatically securing the fixed blade knife 2 to the sheath 6. A resting position of the lock assembly 60 is illustrated in FIGS. 11 and 12. In addition to the automatic securing of the knife, the user of the fixed blade knife 2 may also depress the lock assembly 60 towards the front side 49 of the main portion 24 to allow the hilt 14 to pass over the lock assembly 60. The user may then release the lock assembly 60 to lock the fixed blade knife 2 to the sheath 6. In the lock assembly's resting position, the hilt 14 is substantially secured between the lock assembly 60 and the upper end 44 of the knife receptacle 20 to substantially secure the fixed blade knife 2 to the sheath 6.

When removing the fixed blade knife 2 from the receptacle 20, the lock assembly 60 may first clear the hilt's 14 path. To clear the hilt's 14 path, the lock assembly 60 may be depressed towards the front side 49 of the main portion 24 substantially clearing the path of the hilt 14 before pulling the blade 10 from the knife receptacle 20. If the lock assembly 60 is not depressed before trying to remove the fixed blade knife 2 from the knife receptacle 20, the hilt 14 will make contact with the lock assembly 60. This contact will substantially prevent the removal of the fixed blade knife 2. More specifically, when the fixed blade knife 2 is pulled toward the lock assembly 60, downward forces are created by the lock spring 118 to substantially prevent the hilt 14 from bypassing the lock assembly 60 by mere pulling on the fixed blade knife 2.

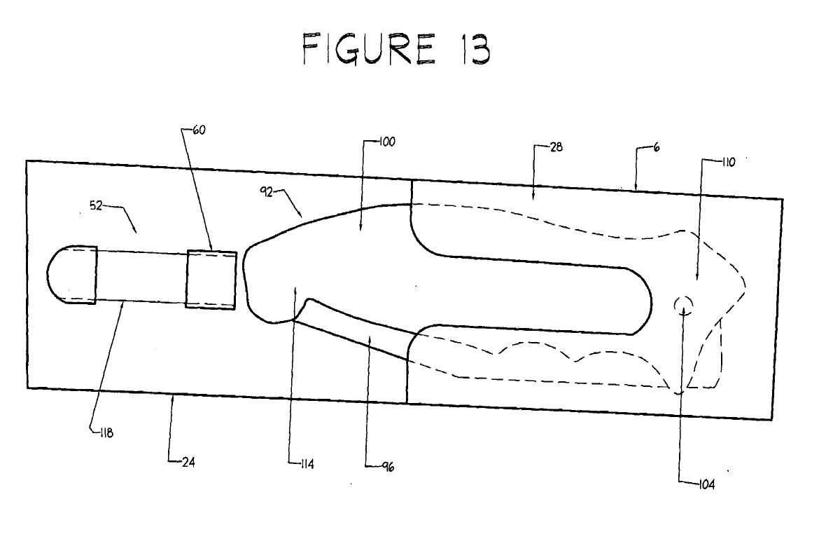

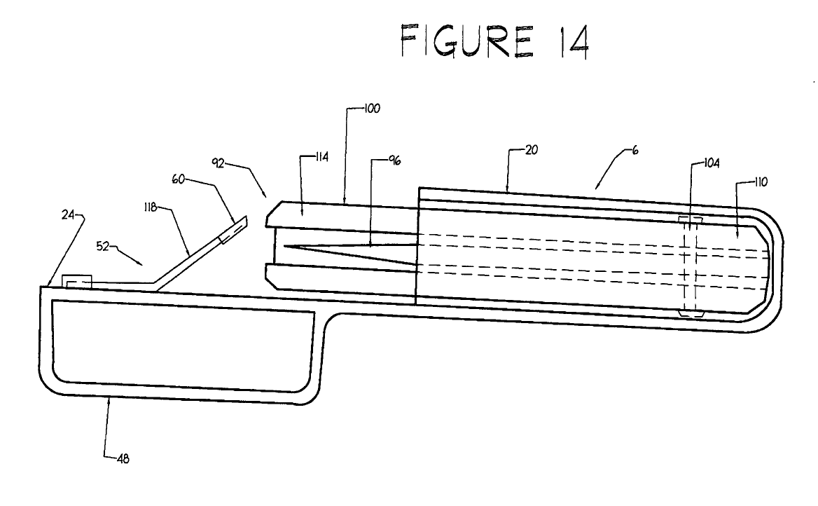

FIGS. 13 and 14 further illustrate the third exemplary embodiment wherein the embodiment is being used in conjunction with a foldable knife 92. The foldable knife 92 may consist of a blade 96 and a handle 100 extending from the blade 96. A folding point 104 may be located at a first handle end 110 to allow the blade 96 to substantially fold into the handle 100. When the blade 96 is folded into the handle 100, the foldable knife 92 may be in a folded position, as illustrated.

In this example, opposite the first handle end 110 is a second handle end 114. To secure the foldable knife 92 within the sheath 6, the foldable knife 92 is first folded. Next, the foldable knife 92 is inserted into the knife receptacle 20 such that the lock assembly 60 may engage the second handle end 114. The lock assembly 60 may be sized large enough to secure the foldable knife 92 to the sheath while remaining small enough to allow removal of the foldable knife 92 from the sheath 6. When the lock assembly 60 is substantially depressed towards the front side 49 of the main portion 24 the lock assembly may be sized to allow the foldable knife 92 to substantially clear the lock assembly 60 from the path of the second handle end 114. Then the foldable knife 92 may be removed from the sheath 6.

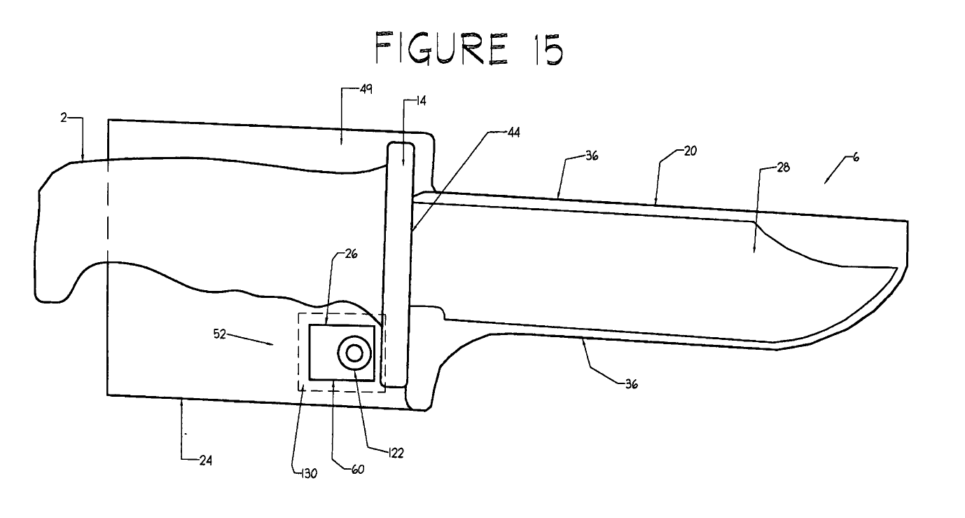

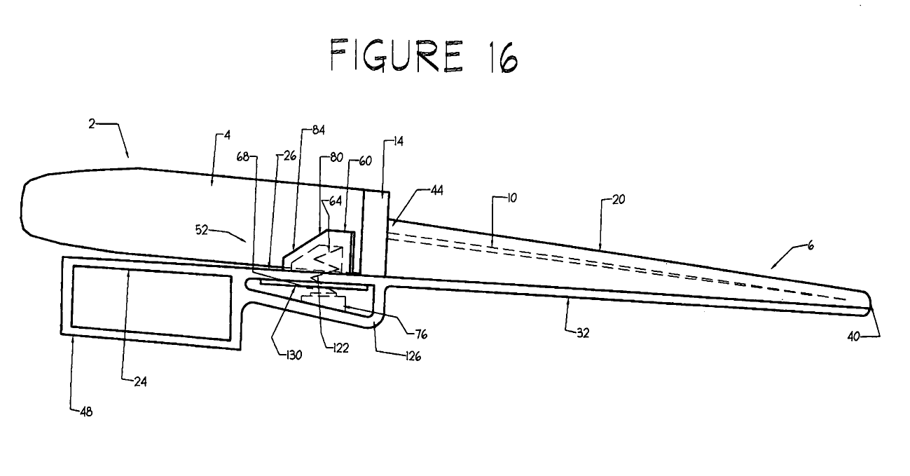

FIGS. 15 and 16 illustrate a fourth exemplary embodiment of the locking mechanism 52. For brevity, detailed descriptions of the knife and sheath will not be repeated. The locking mechanism 52 of FIGS. 15 and 16 may include a coil spring 122 and lock assembly 60. More specifically, the coil spring 122 may have a first spring area 64 and a second spring area 68. The first spring area 64 and the second spring area 68 may be opposite ends of a single coil spring 122. In this exemplary embodiment a recessed main portion 126 is formed at the back side 32 of the main portion 24. The recessed main portion 126 may be, for example, between the belt loop 48 and the upper end 44 of the knife receptacle 20 as illustrated in FIG. 16. The coil spring 122 can be substantially located between the recessed main portion 126 and the lock assembly 60. The coil spring 122 thus may pass through an opening 26 in the main portion 24. The first spring area 64 may be workably attached to the recessed main portion 126. The second spring area 68 may be located substantially within the lock assembly 60, and can be workably attached to the second assembly end 80 of the lock assembly 60. The recessed main portion 126 can be spaced a distance away from the back side 32 of the main portion 24 to allow both the lock assembly 60 and the coil spring 122 to pass through the opening 26 in the main portion 24. The size of the opening 26 in the main portion 24 can be substantially large enough to allow the lock assembly 60 pass through the main portion 24, but may not allow a flange 130, which can be connected to the first assembly end 76 of the lock assembly 60, to pass through the opening 26 of the main portion 24.

FIG. 16 provides a side view of the locking mechanism 52 according to the fourth exemplary embodiment. The lock assembly 60 may have a substantially cube like shape having a first assembly end 76 attached to the flange 130, and having a second assembly end 80 protruding through the back side 32 of the main portion 24 and over the hilt 14 of the fixed blade knife 2. The cubical corner of the second assembly end 80 that is furthest away from the knife receptacle 20 can be rounded to create a rounded corner 84, as illustrated in FIG. 16. The lock assembly 60 may be attached to the distal end of the second spring area 68, forming a substantially cubical structure around the second spring area 68 of the spring as illustrated in FIG. 16. For example, the lock assembly 60 too may be hollow to receive the end of the coil spring 122. The second spring area 68 along with the second assembly end 80 of the lock assembly 60 may substantially protrude over the hilt 14 of the fixed blade knife 2 while the flange 130 remains on the back side 32 of the sheath 6.

According to the fourth exemplary embodiment, when the blade 10 of the fixed blade knife 2 is inserted into the knife receptacle 20, the fixed blade knife 2 is substantially automatically locked to the sheath 6 by the locking mechanism 52. The rounded corner 84 of the lock assembly 60 will allow the hilt 14 and blade 10 to more easily pass over the lock assembly 60 with little resistance when the fixed blade knife 2 is inserted into the knife receptacle 20. As the hilt 14 or blade 10 passes over the lock assembly 60, the lock assembly 60 is depressed with minimal resistance from the coil spring 122 through the opening 26 in the main portion 24 and substantially towards the recessed main portion 126. Once the hilt 14 passes over the lock assembly 60, the second assembly end 80 of the lock assembly 60 springs back to its resting position through the opening 26 in the main portion 24 and back over and above the hilt 14, thus substantially automatically securing the fixed blade knife 2 to the sheath 6. The flange 130 substantially presses against the back side 32 of the main portion 24 while the lock assembly is in its resting position. A resting position of the lock assembly 60 is illustrated in FIGS. 15 and 16. In addition to the automatic securing of the knife, the user of the fixed blade knife 2 may also depress the lock assembly 60 through the opening 26 in the main portion 24 to allow the hilt 14 to pass over the lock assembly 60. The user may then release the lock assembly 60 to lock the fixed blade knife 2 to the sheath 6. In the lock assembly's resting position, the hilt 14 is secured between the lock assembly 60 and the upper end 44 of the knife receptacle 20 to substantially secure the fixed blade knife 2 to the sheath 6.

When removing the fixed blade knife 2 from the receptacle 20, the second assembly end 80 of the lock assembly 60 may first clear the hilt's 14 path. To clear the hilt's 14 path, the lock assembly 60 may be depressed through the opening 26 in the main portion 24 clearing the path of the hilt 14 before pulling the blade 10 from the knife receptacle 20. If the lock assembly 60 is not depressed before trying to remove the fixed blade knife 2 from the knife receptacle 20, the hilt 14 will make contact with the lock assembly 60. This contact will substantially prevent the removal of the fixed blade knife 2. More specifically, when the fixed blade knife 2 is pulled toward the lock assembly 60, the hilt 14 may substantially abut the lock assembly end that is substantially adjacent the hilt 14. Thus, the lock assembly 60 substantially preventing the hilt 14 from bypassing the lock assembly 60 by mere pulling on the fixed blade knife 2.

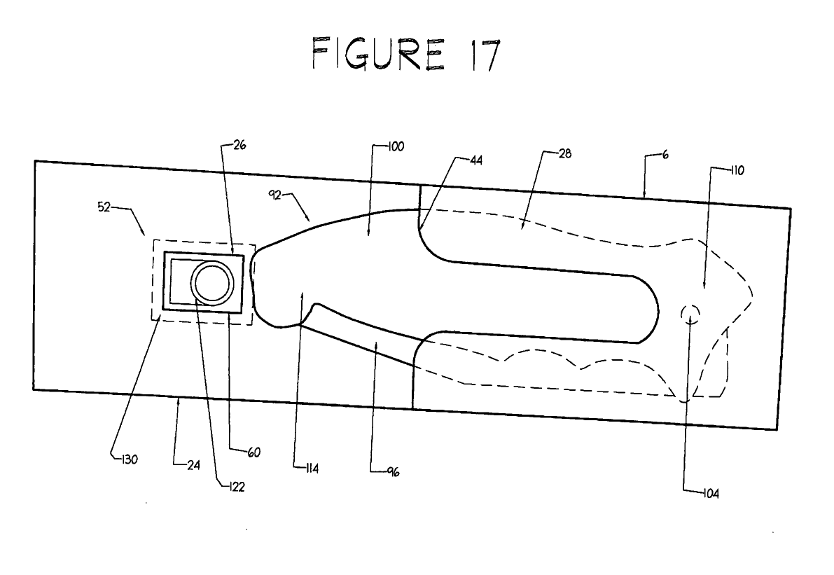

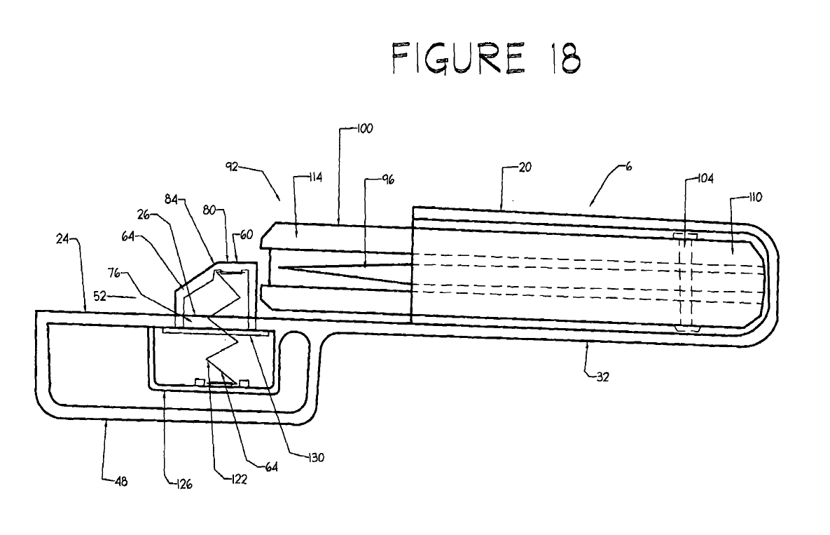

FIGS. 17 and 18 further illustrate the fourth exemplary embodiment wherein the embodiment is being used in conjunction with a foldable knife 92. In this example, opposite the first handle end 110 is a second handle end 114. To secure the foldable knife 92 within the sheath 6, the foldable knife 92 is first folded. Next, the foldable knife 92 is inserted into the knife receptacle 20 such that the lock assembly 60 may engage the second handle end 114. To remove the foldable knife 92 from the sheath 6, the lock assembly 60 may be depressed through the opening 26 in the main portion 24 and towards the recessed main portion 126. To substantially clear the lock assembly 60 from the path of the second handle end 114 the recessed main portion 126 can be substantially spaced a distance away from the back side 32 of the main portion 24 to allow the coil spring 122 and lock assembly 60 to recede into the opening 26 of the main portion 24. Then the foldable knife 92 can pass over the lock assembly 60 and compressed coil spring 122 allowing the user to remove the knife from the sheath 6.

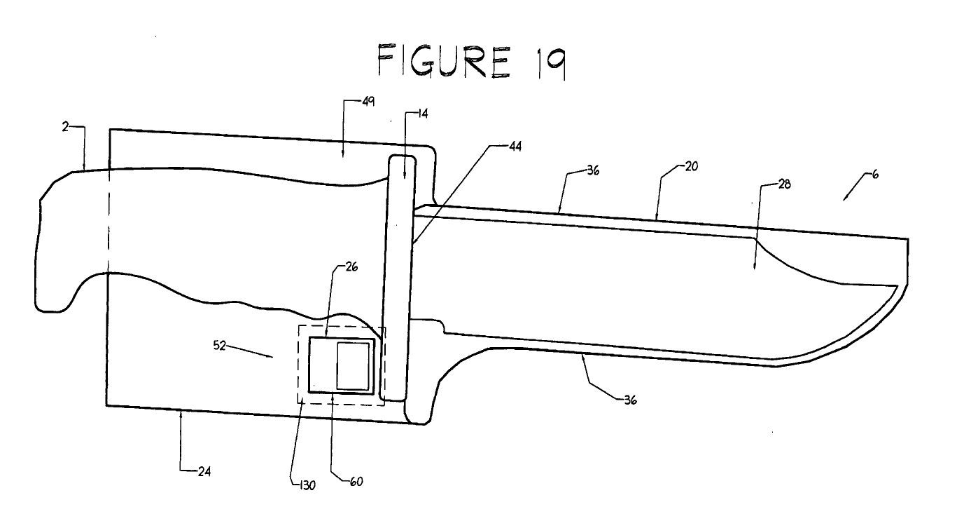

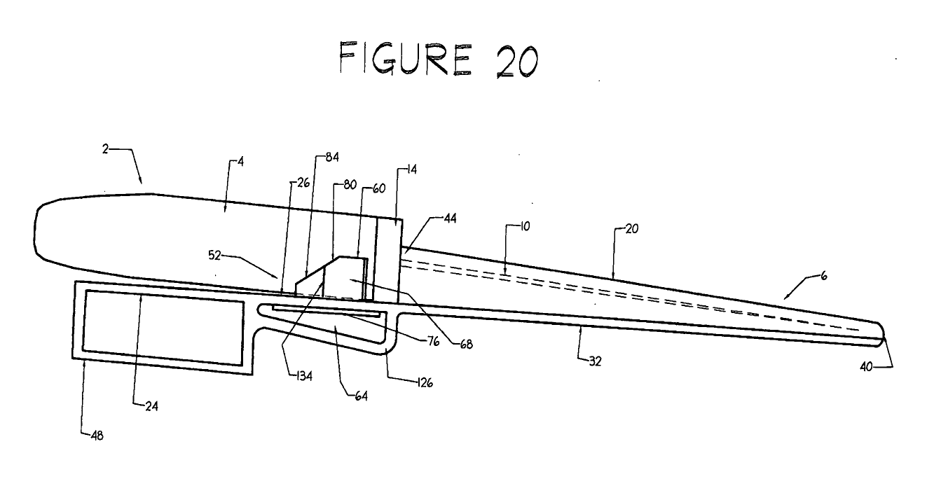

FIGS. 19 and 20 illustrate a fifth exemplary embodiment of the locking mechanism 52. For brevity, detailed descriptions of the knife and sheath will not be repeated. The locking mechanism 52 of FIGS. 19 and 20 may include a foam spring 134 and lock assembly 60. Additionally, the foam spring 134 may be constructed of, but not limited to, silicon rubber, resilient putty, rubber, or any resilient type material or structure that substantially compresses and substantially returns to an uncompressed state. More specifically, the foam spring 134 may have a first spring area 64 and a second spring area 68. The first spring area 64 and the second spring area 68 may be opposite ends of a single foam spring 134. In this exemplary embodiment a recessed main portion 126 is formed at the back side 32 of the main portion 24, for example, between the belt loop 48 and the upper end 44 of the knife receptacle 20 as illustrated in FIG. 20. The foam spring 134 can be substantially located between the recessed main portion 126 and the lock assembly 60. The foam spring 134 passing through an opening 26 in the main portion 24. The first spring area 64 may be workably attached to the recessed main portion 126. The second spring area 68 may be workably attached to the second assembly end 80 of the lock assembly 60. The recessed main portion 126 can be spaced a distance away from the back side 32 of the main portion 24 to allow both the lock assembly 60 and the foam spring 134 to pass through the opening 26 in the main portion 24. The size of the opening 26 in the main portion 24 can be substantially large enough to allow the lock assembly 60 to pass through the main portion 24, but may not allow a flange 130, which can be connected to the first assembly end 76 of the lock assembly 60, to pass through the opening 26 of the main portion 24.

FIG. 20 provides a side view of the locking mechanism 52 according to the fifth exemplary embodiment. The lock assembly 60 may have a substantially cube like shape having a first assembly end 76 attached to the flange 130, and having a second assembly end 80 protruding through the back side 32 of the main portion 24 and over the hilt 14 of the fixed blade knife 2. The cubical corner of the second assembly end 80 that is furthest away from the knife receptacle 20 can be rounded to create a rounded corner 84, as illustrated in FIG. 20. The lock assembly 60 may substantially encase the second spring area 68 as illustrated in FIG. 20. The second spring area 68 along with the second assembly end 80 of the lock assembly 60 may substantially protrude over the hilt 14 of the fixed blade knife 2 while the flange 130 remains on the back side 32 of the sheath 6. As one of skill in the art will appreciate, the shape of the lock assembly may be any shape consistent with the teaching of this disclosure.

According to the fifth exemplary embodiment, when the blade 10 of the fixed blade knife 2 is inserted into the knife receptacle 20, the fixed blade knife 2 is substantially automatically locked to the sheath 6 by the locking mechanism 52. The rounded corner 84 of the lock assembly 60 will allow the hilt 14 and blade 10 to more easily pass over the lock assembly 60 with little resistance when the fixed blade knife 2 is inserted into the knife receptacle 20. As the hilt 14 or blade 10 passes over the lock assembly 60, the lock assembly 60 is depressed with minimal resistance from the foam spring 134 through the opening 26 in the main portion 24 and substantially towards the recessed main portion 126. Once the hilt 14 passes over the lock assembly 60, the second assembly end 80 of the lock assembly 60 springs back to its resting position through the opening 26 in the main portion 24 and back over and above the hilt 14, thus substantially automatically securing the fixed blade knife 2 to the sheath 6. The flange 130 substantially presses against the back side 32 of the main portion 24 while the lock assembly is in its resting position. A resting position of the lock assembly 60 is illustrated in FIGS. 19 and 20. In addition to the automatic securing of the knife, the user of the fixed blade knife 2 may also depress the lock assembly 60 through the opening 26 in the main portion 24 to allow the hilt 14 to pass over the lock assembly 60. The user may then release the lock assembly 60 to substantially lock the fixed blade knife 2 to the sheath 6. In the lock assembly's resting position, the hilt 14 is substantially secured between the lock assembly 60 and the upper end 44 of the knife receptacle 20 to substantially secure the fixed blade knife 2 to the sheath 6.

When removing the fixed blade knife 2 from the receptacle 20, the second assembly end 80 of the lock assembly 60 may first clear the hilt's 14 path. To clear the hilt's 14 path, the lock assembly 60 may be depressed through the opening 26 in the main portion 24 clearing the path of the hilt 14 before pulling the blade 10 from the knife receptacle 20. If the lock assembly 60 is not depressed before trying to remove the fixed blade knife 2 from the knife receptacle 20, the hilt 14 will make contact with the lock assembly 60. This contact will substantially prevent the removal of the fixed blade knife 2.

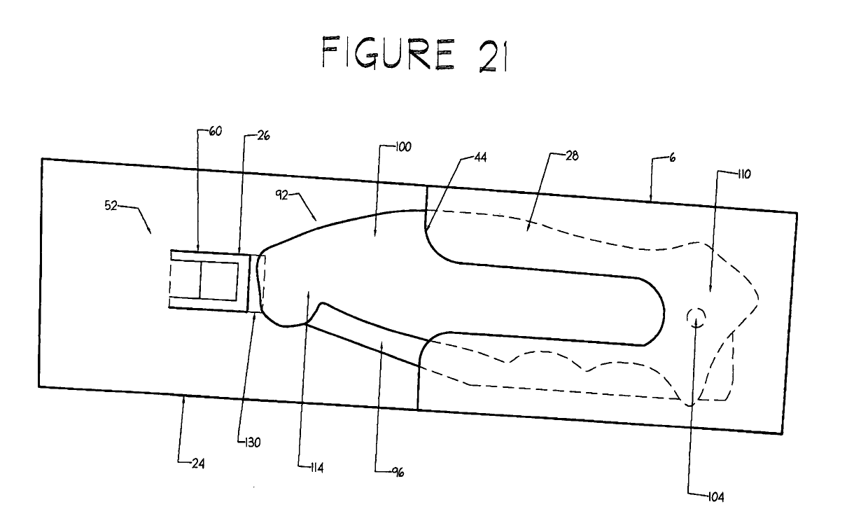

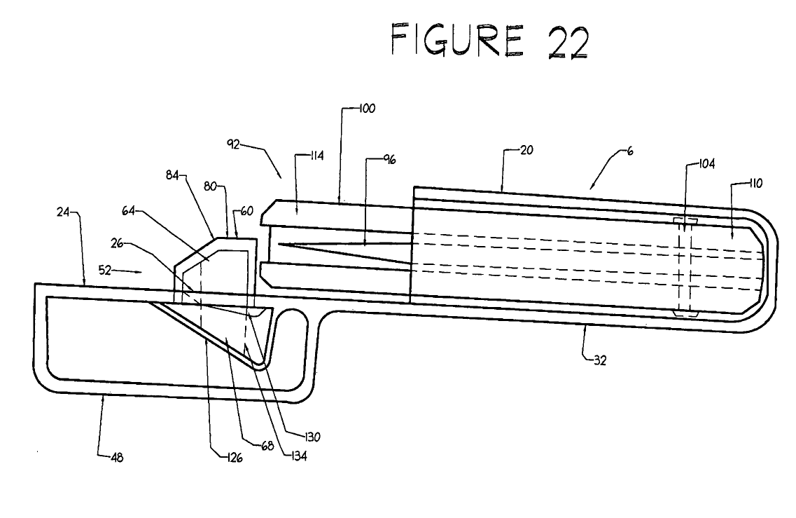

FIGS. 21 and 22 further illustrate the fifth exemplary embodiment wherein the embodiment is being used in conjunction with a foldable knife 92. In this example, opposite the first handle end 110 is a second handle end 114. To secure the foldable knife 92 within the sheath 6, the foldable knife 92 is first folded. Next, the foldable knife 92 is inserted into the knife receptacle 20 such that the lock assembly 60 may engage the second handle end 114 the recessed main portion 126 can be substantially spaced a distance away from the back side 32 of the main portion 24 to allow the foam spring 134 and lock assembly 60 to recede into the opening 26 of the main portion 24. Then the foldable knife 92 can pass over the lock assembly 60 and compress foam spring 134, to allow the user to remove the knife from the sheath 6.

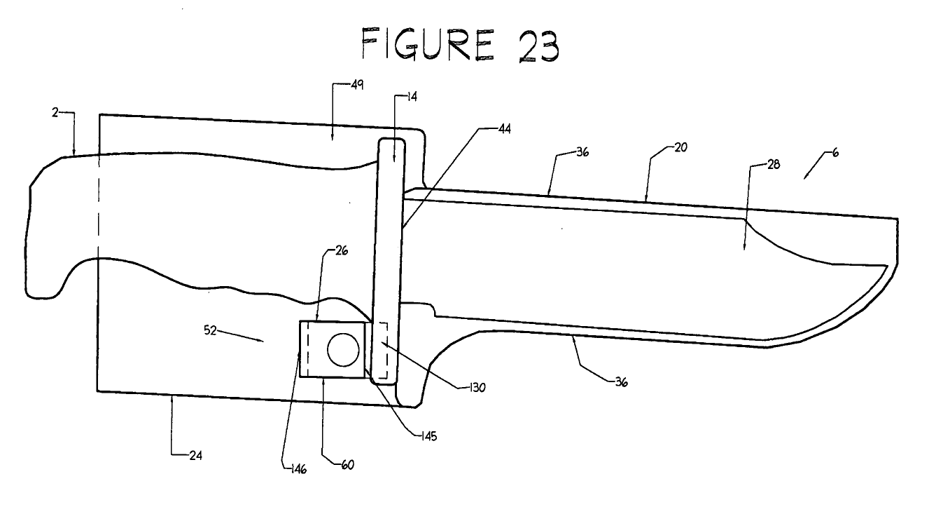

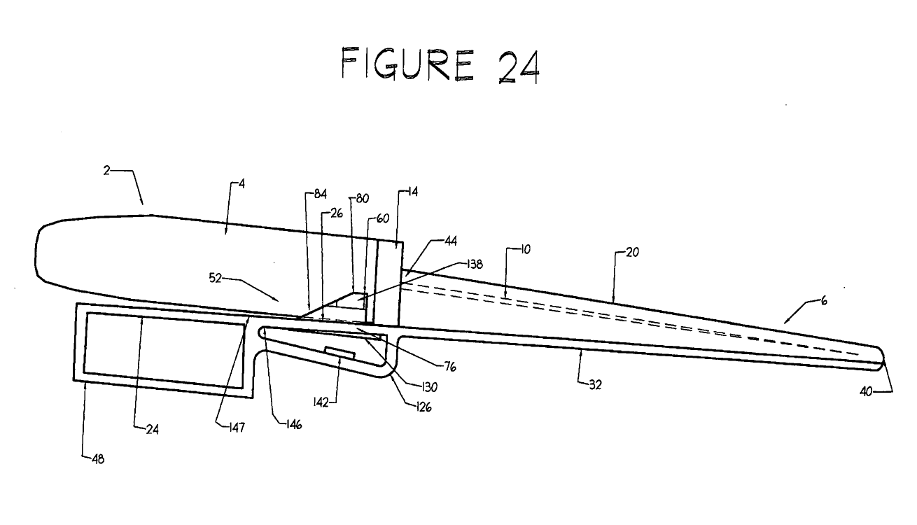

FIGS. 23 and 24 illustrate a sixth exemplary embodiment of the locking mechanism 52. For brevity, detailed descriptions of the knife and sheath will not be repeated. The locking mechanism 52 of FIGS. 23 and 24 may include two opposing magnets and a lock assembly 60. In this exemplary embodiment a recessed main portion 126 is formed at the back side 32 of the main portion 24, for example, between the belt loop 48 and the upper end 44 of the knife receptacle 20 as illustrated in FIG. 24. A recessed main portion magnet 142 can be attached to the recessed main portion 126 and can be substantially located between the recessed main portion 126 and the lock assembly 60. An assembly magnet 138 can be attached to the second assembly end 80 of the lock assembly 60 and can be substantially located between the recessed main portion 126 and the lock assembly 60. The recessed main portion magnet 142 may be positioned to substantially repel the recessed assembly magnet 138. The recessed main portion 126 can be spaced a distance away from the back side 32 of the main portion 24 to allow both the lock assembly 60 and the assembly magnet 138 to pass through the opening 26 in the main portion 24. The size of the opening 26 in the main portion 24 can be substantially large enough to allow the lock assembly 60 to pass through the main portion 24, but may not allow a flange 130, which can be connected to the first assembly end 76 of the lock assembly 60, to pass through the opening 26 of the main portion 24. The first assembly end 76 may be substantially opposed to the flange 130 of the lock assembly 60 and can be attached to the main portion by any means known in the art. For example, the assembly end 76 opposed to the flange 130 may be attached to a first hinge end 145 of a hinge 146 for allowing the lock assembly 60 to substantially pivot around the hinge 146. Distal to the first hinge end 145 there may be a second hinge end 147 for workably attaching the hinge 146 to the main portion 24.

FIG. 24 provides a side view of the locking mechanism 52 according to the sixth exemplary embodiment. The lock assembly 60 may have a substantially cube like shape having a first assembly end 76 attached to both, the flange 130 and opposed to the flange 130, a hinge 146. The lock assembly 60 may also have a second assembly end 80 protruding through the back side 32 of the main portion 24 and over the hilt 14 of the fixed blade knife 2. The cubical corner of the second assembly end 80 that is furthest away from the knife receptacle 20 can be rounded to create a rounded corner 84, as illustrated in FIG. 24. The lock assembly 60 may substantially encase the assembly magnet 138 as illustrated in FIG. 24. The assembly magnet 138 along with the second assembly end 80 of the lock assembly 60 may substantially protrude over the hilt 14 of the fixed blade knife 2 while the flange 130 remains on the back side 32 of the sheath 6. As one of skill in the art will appreciate, the shape of the lock assembly may be any shape consistent with the teaching of this disclosure.

According to the sixth exemplary embodiment, when the blade 10 of the fixed blade knife 2 is inserted into the knife receptacle 20, the fixed blade knife 2 is substantially automatically locked to the sheath 6 by the locking mechanism 52. The rounded corner 84 of the lock assembly 60 will allow the hilt 14 and blade 10 to more easily pass over the lock assembly 60 with little resistance when the fixed blade knife 2 is inserted into the knife receptacle 20. As the hilt 14 or blade 10 passes over the lock assembly 60, the lock assembly 60 is depressed with minimal resistance, from the repelling force between the assembly magnet 138 and the recessed main portion magnet 142, through the opening 26 in the main portion 24 and substantially towards the recessed main portion 126. Once the hilt 14 passes over the lock assembly 60, the second assembly end 80 of the lock assembly 60 repels back to its resting position through the opening 26 in the main portion 24 and back over and above the hilt 14, thus substantially automatically securing the fixed blade knife 2 to the sheath 6. The flange 130 substantially pressing against the back side 32 of the main portion 24 while the lock assembly is in its resting position. A resting position of the lock assembly 60 is illustrated in FIGS. 23 and 24. In addition to the automatic securing of the knife, the user of the fixed blade knife 2 may also depress the lock assembly 60 through the opening 26 in the main portion 24 to allow the hilt 14 to pass over the lock assembly 60. The user may then release the lock assembly 60 to lock the fixed blade knife 2 to the sheath 6. In the lock assembly's resting position, the hilt 14 is substantially secured between the lock assembly 60 and the upper end 44 of the knife receptacle 20 to substantially secure the fixed blade knife 2 to the sheath 6.

When removing the fixed blade knife 2 from the receptacle 20, the second assembly end 80 of the lock assembly 60 may first clear the hilt's 14 path. To clear the hilt's 14 path, the lock assembly 60 may be depressed through the opening 26 in the main portion 24 clearing the path of the hilt 14 before pulling the blade 10 from the knife receptacle 20. If the lock assembly 60 is not depressed before trying to remove the fixed blade knife 2 from the knife receptacle 20, the hilt 14 will make contact with the lock assembly 60. This contact will substantially prevent the removal of the fixed blade knife 2.

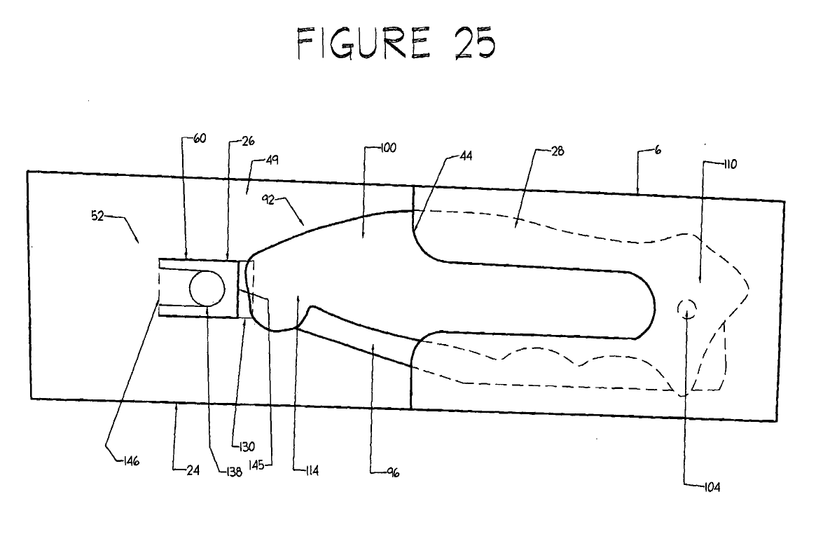

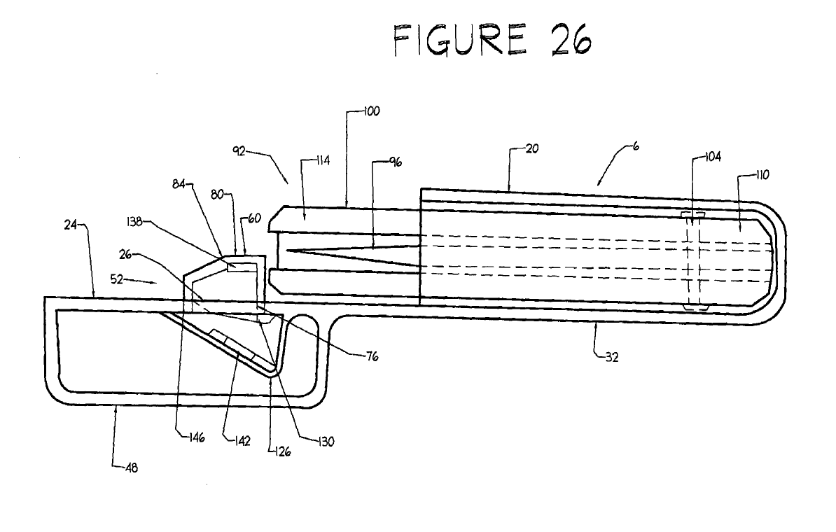

FIGS. 25 and 26 further illustrate the sixth exemplary embodiment wherein the embodiment is being used in conjunction with a foldable knife 92. In this example, to secure the foldable knife 92 within the sheath 6, the foldable knife 92 is first folded. Next, the foldable knife 92 is inserted into the knife receptacle 20. To insert the foldable knife 92 into the knife receptacle 20 the user may substantially depress the lock assembly 60 with substantially enough force to overcome the repelling force between the assembly magnet 138 and the recessed main portion magnet 142. The lock assembly 60 may then substantially pivot around the hinge 146 and into an opening 26 in the main portion 24 towards the recessed main portion 126 to allow the foldable knife 92 to enter into the knife receptacle 20 with substantially minimal obstruction from the lock assembly 60. After the foldable knife 92 is substantially located within the knife receptacle 20 and the lock assembly 60 is no longer depressed with enough force to overcome the repelling force between the magnets, the lock assembly 60 can substantially pivot around the hinge 146 towards the front side 49 of the main portion 60 until the flange 130 substantially makes contact with the back side 32 of the knife sheath 6. With the flange 130 substantially making contact with the back side 32, the second assembly end 80 of the lock assembly 60 can substantially protrude over the foldable knife 92 to substantially secure the knife within the knife sheath 6. To remove the foldable knife 92 from the sheath 6, the lock assembly 60 may be depressed with enough force to overcome the repelling force of the magnets allowing the lock assembly 60 to recede into the opening 26 in the main portion 24 to substantially clear the lock assembly 60 from the path of the foldable knife 92. The foldable knife 92 can then be removed from the sheath 6.

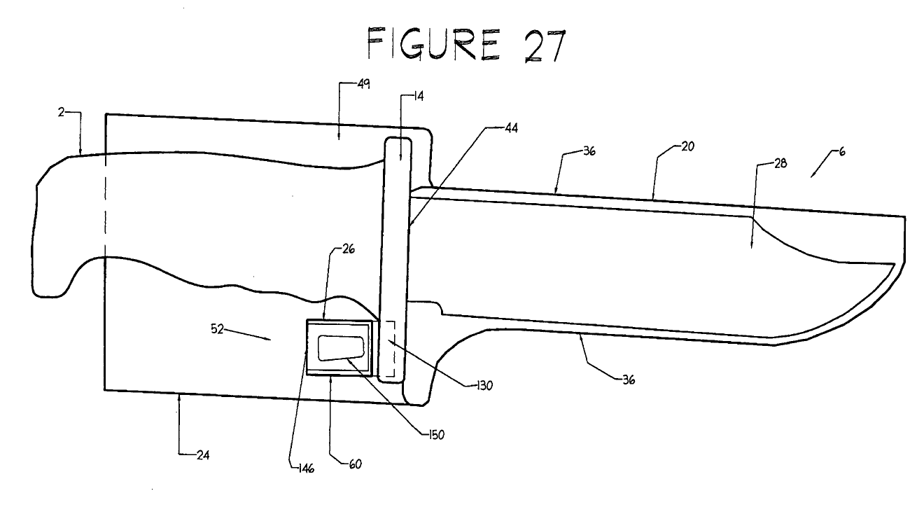

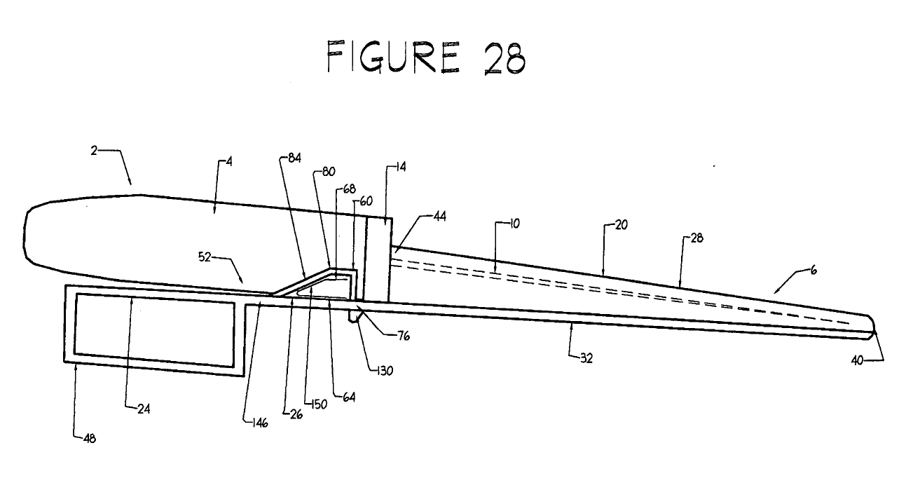

FIGS. 27 and 28 illustrate a seventh exemplary embodiment of the locking mechanism 52. For brevity, detailed descriptions of the knife and sheath will not be repeated. The locking mechanism 52 of FIGS. 27 and 28 may include a bent leaf spring 150, and lock assembly 60. More specifically, the bent leaf spring 150 may have a first spring area 64 and a second spring area 68. The first spring area 64 and the second spring area 68 may be opposite ends of a single bent leaf spring 150. The bent leaf spring 150 can be substantially located between the front side 49 of the main portion 24 and the lock assembly 60. The first spring area 64 can be workably attached to the front side 49 of the main portion 24 and the second spring area 68 can be workably attached to the second assembly end 80 of the lock assembly 60. The size of the opening 26 in the main portion 24 can be substantially large enough to allow the first assembly end 76 of the lock assembly 60 to pass through the main portion 24 but may not allow a flange 130, which can be connected to the first assembly end 76 of the lock assembly 60, to pass through the opening 26 of the main portion 24. The first assembly end 76 substantially opposed to the flange 130, of the lock assembly 60, can be attached to the main portion by any means known in the art.

FIG. 28 provides a side view of the locking mechanism 52 according to the seventh exemplary embodiment. The lock assembly 60 may have a substantially cube like shape having a first assembly end 76. Attached to the cubical corner of the first assembly end 76 and closest to the upper end 44 of the knife receptacle 20 is a flange 130. The cubical corner distal the flange 130 and on the first assembly end 76 of the lock assembly 60 may be attached to the front side 49 of the main portion 24 through a hinge 146 (not shown) or by any other means of attaching known in the art. The lock assembly 60 may also have a second assembly end 80 substantially protruding over the hilt 14 of the fixed blade knife 2. The cubical corner of the second assembly end 80 that is furthest away from the knife receptacle 20 can be rounded to create a rounded corner 84, as illustrated in FIG. 28. A bent leaf spring 150 can be located between the lock assembly 60 and the front side 49 of the main portion 60 as illustrated in FIG. 28. The bent leaf spring 150 along with the second assembly end 80 of the lock assembly 60 may substantially protrude over the hilt 14 of the fixed blade knife 2 while the flange 130 remains on the back side 32 of the sheath 6.

According to the seventh exemplary embodiment, when the blade 10 of the fixed blade knife 2 is inserted into the knife receptacle 20, the fixed blade knife 2 is substantially automatically locked to the sheath 6 by the locking mechanism 52. The rounded corner 84 of the lock assembly 60 will allow the hilt 14 and blade 10 to more easily pass over the lock assembly 60 with little resistance when the fixed blade knife 2 is inserted into the knife receptacle 20. As the hilt 14 or blade 10 passes over the lock assembly 60, the lock assembly 60 is depressed with minimal resistance from the bent leaf spring 150 substantially pushing the flange 130 side of the lock assembly 60 through the opening 26 in the main portion 24 and substantially towards the front side 49 of the main portion 24. Once the hilt 14 passes over the lock assembly 60, the second assembly end 80 of the lock assembly 60 is sprung back, by the bent leaf spring, to its resting position substantially over and above the hilt 14. Thus substantially automatically securing the fixed blade knife 2 to the sheath 6. The flange 130 substantially pressing against the back side 32 of the main portion 24 while the lock assembly is in its resting position. A resting position of the lock assembly 60 is illustrated in FIGS. 27 and 28. In addition to the automatic securing of the knife, the user of the fixed blade knife 2 may also depress the lock assembly 60 through the opening 26 in the main portion 24 to allow the hilt 14 to pass over the lock assembly 60. The user may then release the lock assembly 60 to lock the fixed blade knife 2 to the sheath 6. In the lock assembly's resting position, the hilt 14 is secured between the lock assembly 60 and the upper end 44 of the knife receptacle 20 to substantially secure the fixed blade knife 2 to the sheath 6. As one of skill in the art will appreciate, the shape of the lock assembly may be any shape consistent with the teaching of this disclosure.

When removing the fixed blade knife 2 from the receptacle 20, the second assembly end 80 of the lock assembly 60 may first clear the hilt's 14 path. To clear the hilt's 14 path, the flange 130 corner of the lock assembly 60 may be substantially depressed through the opening 26 in the main portion 24 clearing the path of the hilt 14 before pulling the blade 10 from the knife receptacle 20. If the lock assembly 60 is not depressed before trying to remove the fixed blade knife 2 from the knife receptacle 20, the hilt 14 will make contact with the lock assembly 60. This contact will substantially prevent the removal of the fixed blade knife 2.

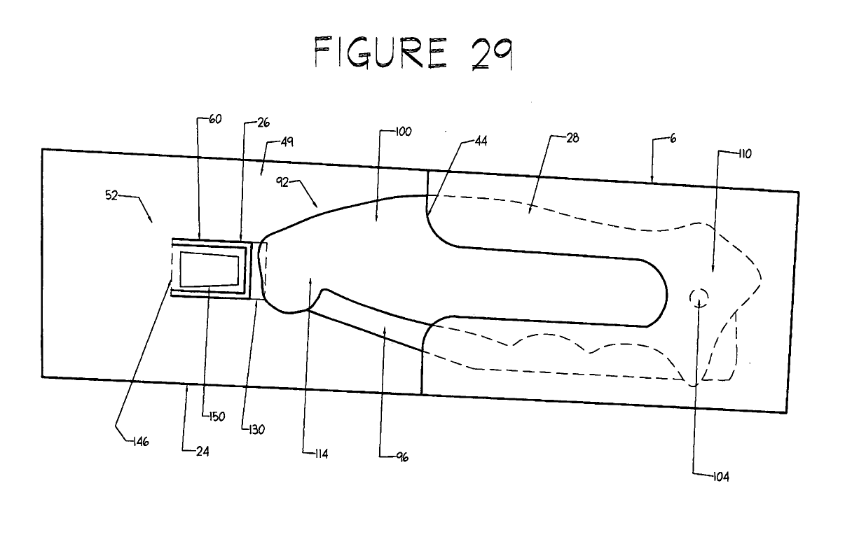

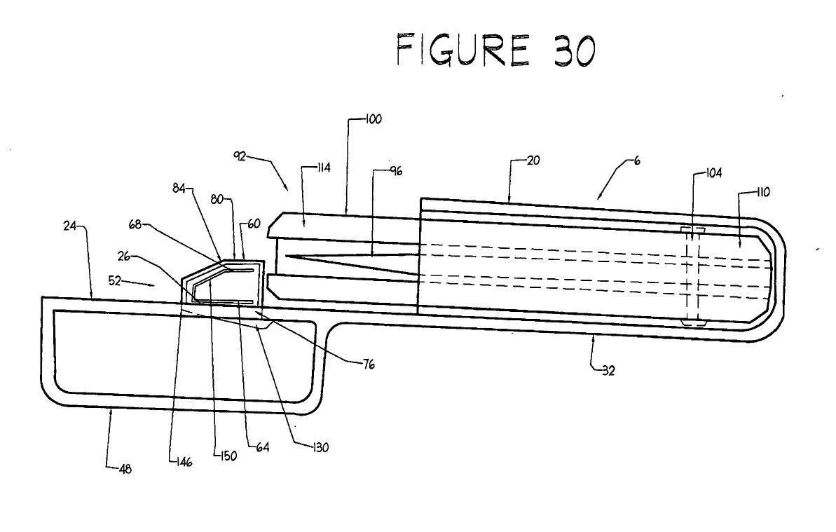

FIGS. 29 and 30 further illustrate the seventh exemplary embodiment wherein the embodiment is being used in conjunction with a foldable knife 92. In this example, to secure the foldable knife 92 within the sheath 6, the foldable knife 92 is first folded. Next, the foldable knife 92 is inserted into the knife receptacle 20. To insert the foldable knife 92 into the knife receptacle 20 the user may substantially depress the lock assembly 60 with substantially enough force to compress the bent leaf spring 150. The flange 130 corner of the lock assembly 60 may then travel through the opening 26 in the main portion 24 towards the recessed main portion 126 to allow the foldable knife 92 to enter into the knife receptacle 20 with substantially minimal obstruction from the lock assembly 60. After the foldable knife 92 is substantially located within the knife receptacle 20 and the lock assembly 60 is no longer depressed with enough force to compress the bent leaf spring 150, thereby allowing the flange 130 to make substantial contact with the back side 32 of the knife sheath 6. With the flange 130 substantially making contact with the back side 32, the second assembly end 80 of the lock assembly 60 can substantially protrude over the foldable knife 92 to substantially secure the knife within the knife sheath 6. To remove the foldable knife 92 from the sheath 6, the lock assembly 60 may be depressed with enough force to compress the bent leaf spring 150 allowing the flange 130 corner of the lock assembly 60 to recede into the opening 26 in the main portion 24 to substantially clear the lock assembly 60 from the path of the foldable knife 92. The foldable knife 92 can then be removed from the sheath 6.

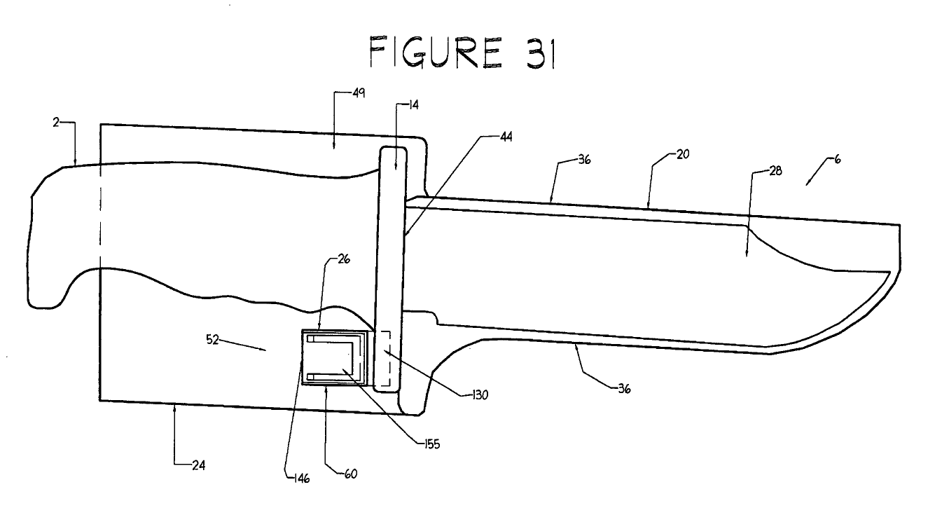

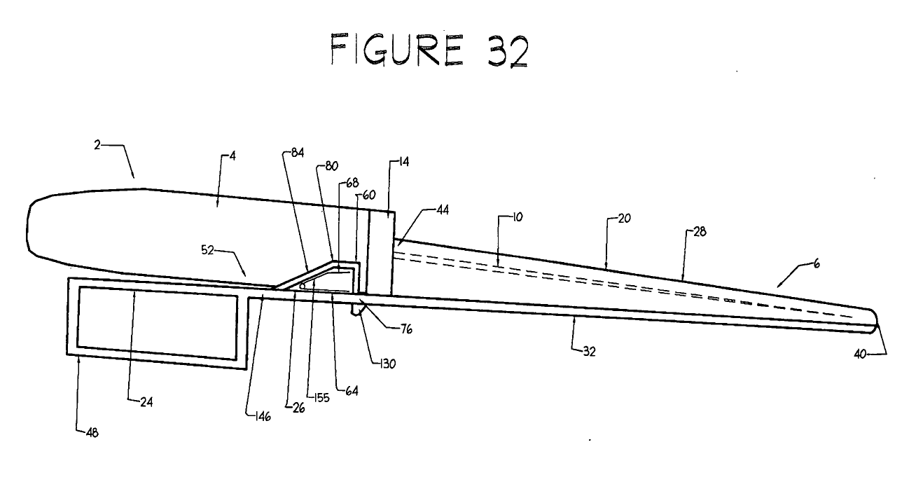

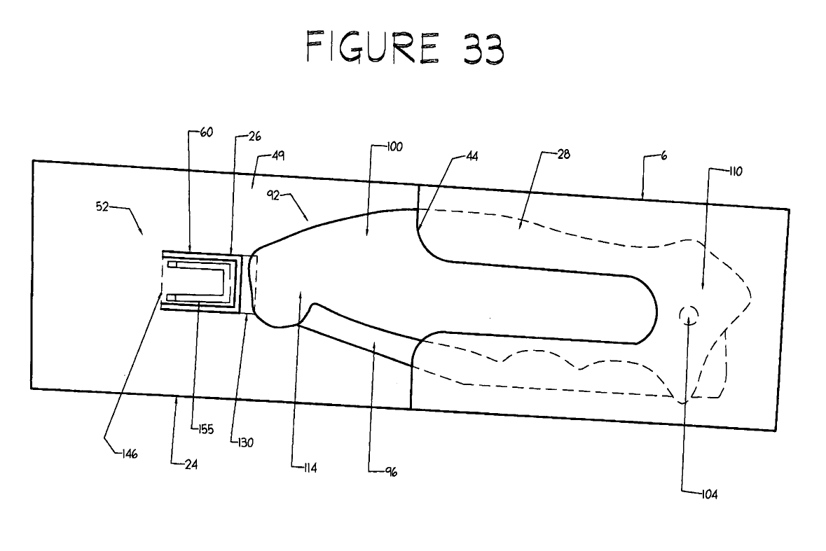

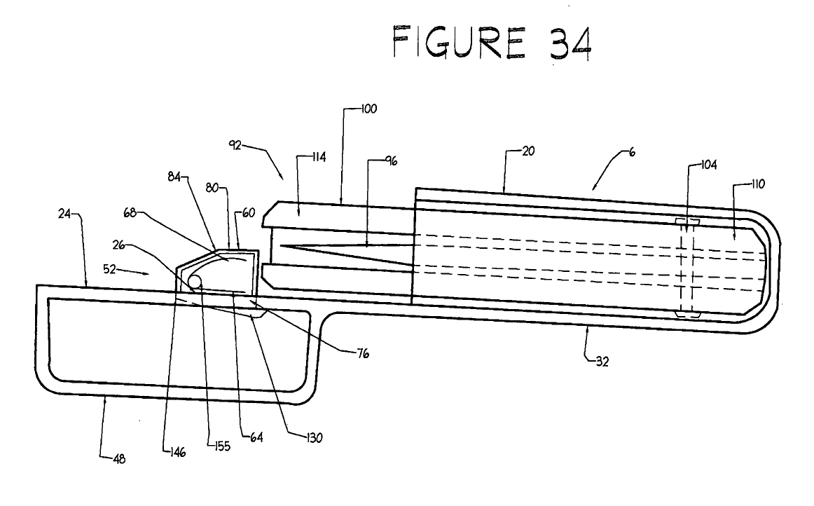

Additionally the bent leaf spring 150 of the seventh embodiment discussed above may be replaced with a safety pin type spring 155. This eighth embodiment is illustrated in FIGS. 31-34.

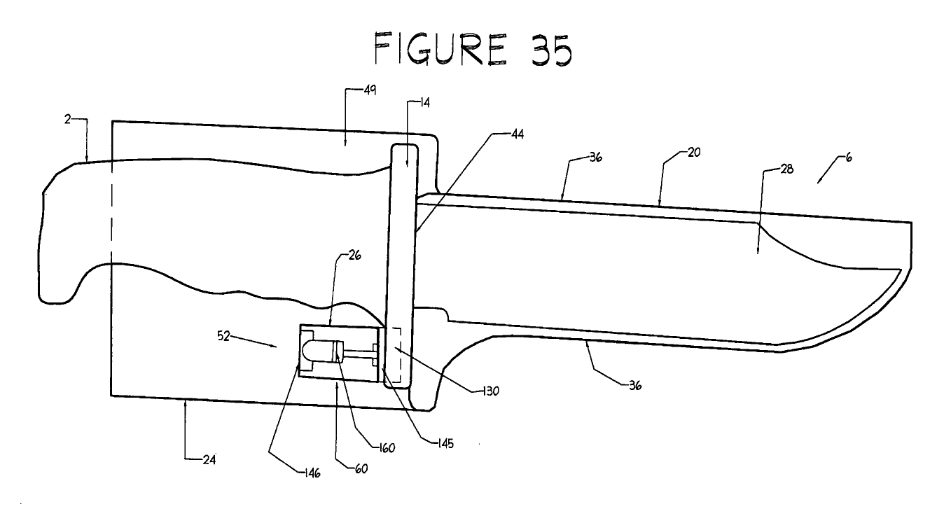

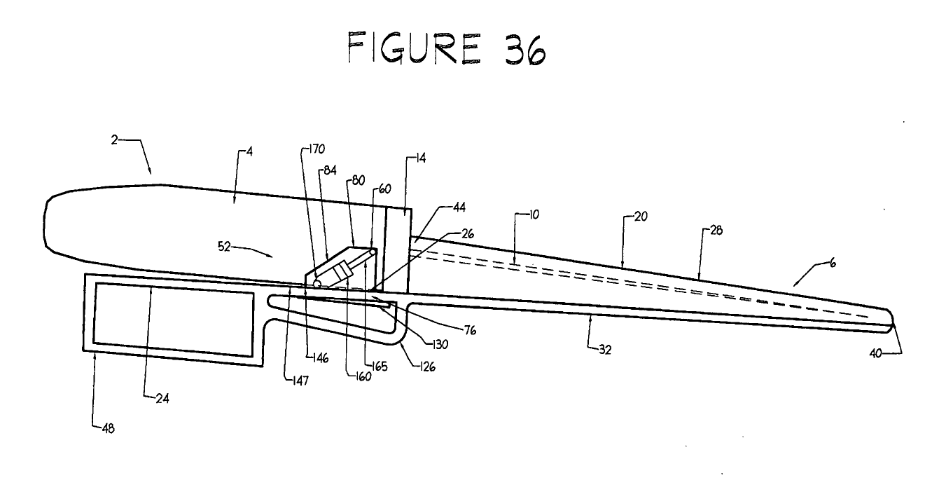

FIGS. 35 and 36 illustrate a ninth exemplary embodiment of the locking mechanism 52. For brevity, detailed descriptions of the knife and sheath will not be repeated. The locking mechanism 52 of FIGS. 35 and 36 may include but is not limited to a gas or oil filled strut or shock 160 and a lock assembly 60. In this exemplary embodiment a recessed main portion 126 is formed at the back side 32 of the main portion 24, for example, between the belt loop 48 and the upper end 44 of the knife receptacle 20 as illustrated in FIG. 36. A second strut area 165 of the strut 160 may be attached to the second assembly end 80 of the lock assembly 60. A first strut area 170 of the strut 160 may be adjacent the main portion 24. The recessed main portion 126 can be spaced a distance away from the back side 32 of the main portion 24 to allow both the lock assembly 60 and the strut 160 to pass through the opening 26 in the main portion 24. The size of the opening 26 in the main portion 24 can be substantially large enough to allow the lock assembly 60 to pass through the main portion 24, but may not allow a flange 130, which can be connected to the first assembly end 76 of the lock assembly 60, to pass through the opening 26 of the main portion 24. The first assembly end 76 may be substantially opposed to the flange 130 of the lock assembly 60 and can be attached to the main portion by any means known in the art. For example, the assembly end 76 opposed to the flange 130 may be attached to a first hinge end 145 of a hinge 146 for allowing the lock assembly 60 to substantially pivot around the hinge 146. Distal to the first hinge end 145 is a second hinge end 147 for workably attaching the hinge 146 to the main portion 24.

FIG. 36 provides a side view of the locking mechanism 52 according to the ninth exemplary embodiment. The lock assembly 60 may have a substantially cube like shape having a first assembly end 76 attached to both, the flange 130 and opposed to the flange 130, a hinge 146. The lock assembly 60 may also have a second assembly end 80 protruding through the back side 32 of the main portion 24 and over the hilt 14 of the fixed blade knife 2. The cubical corner of the second assembly end 80 that is furthest away from the knife receptacle 20 can be rounded to create a rounded corner 84, as illustrated in FIG. 36. The lock assembly 60 may substantially encase the assembly strut 160 as illustrated in FIG. 36. The strut 160 along with the second assembly end 80 of the lock assembly 60 may substantially protrude over the hilt 14 of the fixed blade knife 2 while the flange 130 remains on the back side 32 of the sheath 6. As one of skill in the art will appreciate, the shape of the lock assembly may be any shape consistent with the teaching of this disclosure.

According to the ninth exemplary embodiment, when the blade 10 of the fixed blade knife 2 is inserted into the knife receptacle 20, the fixed blade knife 2 is substantially automatically locked to the sheath 6 by the locking mechanism 52. The rounded corner 84 of the lock assembly 60 will allow the hilt 14 and blade 10 to more easily pass over the lock assembly 60 with little resistance when the fixed blade knife 2 is inserted into the knife receptacle 20. As the hilt 14 or blade 10 passes over the lock assembly 60, the lock assembly 60 is depressed with minimal resistance, from the repelling force of the strut 160, through the opening 26 in the main portion 24 and substantially towards the recessed main portion 126. Once the hilt 14 passes over the lock assembly 60, the second assembly end 80 of the lock assembly 60 repels back to its resting position through the opening 26 in the main portion 24 and back over and above the hilt 14, thus substantially automatically securing the fixed blade knife 2 to the sheath 6. The flange 130 substantially pressing against the back side 32 of the main portion 24 while the lock assembly is in its resting position. A resting position of the lock assembly 60 is illustrated in FIGS. 35 and 36. In addition to the automatic securing of the knife, the user of the fixed blade knife 2 may also depress the lock assembly 60 through the opening 26 in the main portion 24 to allow the hilt 14 to pass over the lock assembly 60. The user may then release the lock assembly 60 to lock the fixed blade knife 2 to the sheath 6. In the lock assembly's resting position, the hilt 14 is substantially secured between the lock assembly 60 and the upper end 44 of the knife receptacle 20 to substantially secure the fixed blade knife 2 to the sheath 6.

When removing the fixed blade knife 2 from the receptacle 20, the second assembly end 80 of the lock assembly 60 may first clear the hilt's 14 path. To clear the hilt's 14 path, the lock assembly 60 may be depressed through the opening 26 in the main portion 24 clearing the path of the hilt 14 before pulling the blade 10 from the knife receptacle 20. If the lock assembly 60 is not depressed before trying to remove the fixed blade knife 2 from the knife receptacle 20, the hilt 14 will make contact with the lock assembly 60. This contact will substantially prevent the removal of the fixed blade knife 2.

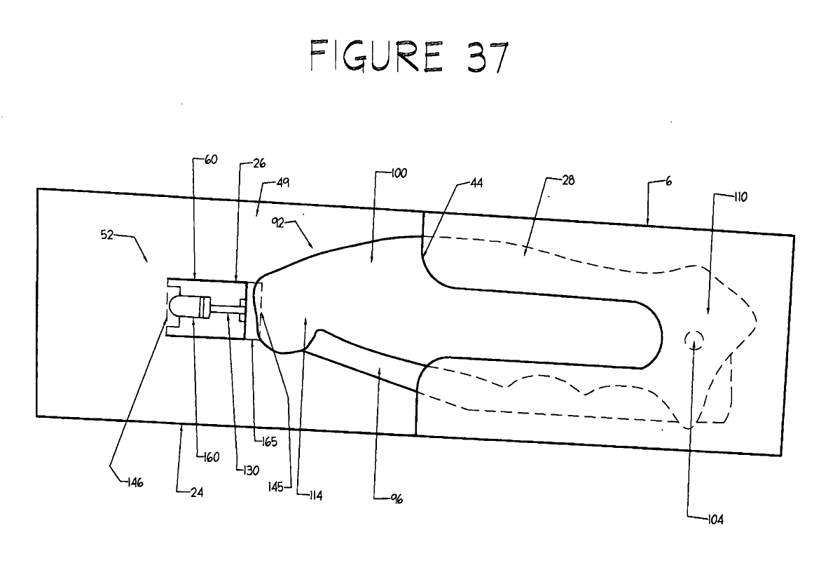

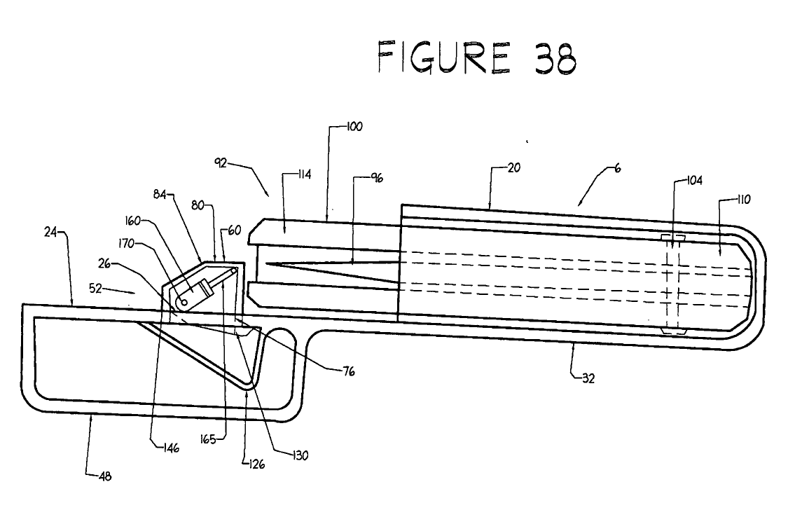

FIGS. 37 and 38 further illustrate the ninth exemplary embodiment wherein the embodiment is being used in conjunction with a foldable knife 92. In this example, to secure the foldable knife 92 within the sheath 6, the foldable knife 92 is first folded. Next, the foldable knife 92 is inserted into the knife receptacle 20. To insert the foldable knife 92 into the knife receptacle 20 the user may substantially depress the lock assembly 60 with substantially enough force to overcome the repelling force of the strut 160. The lock assembly 60 may then substantially pivot around the hinge 146 and into the opening 26 in the main portion 24 towards the recessed main portion 126 to allow the foldable knife 92 to enter into the knife receptacle 20 with substantially minimal obstruction from the lock assembly 60. After the foldable knife 92 is substantially located within the knife receptacle 20 and the lock assembly 60 is no longer depressed with enough force to overcome the repelling force of the strut 160, the lock assembly 60 can substantially pivot around the hinge 146 towards the front side 49 of the main portion 60 until the flange 130 substantially makes contact with the back side 32 of the knife sheath 6. With the flange 130 substantially making contact with the back side 32, the second assembly end 80 of the lock assembly 60 can substantially protrude over the foldable knife 92 to substantially secure the knife within the knife sheath 6. To remove the foldable knife 92 from the sheath 6, the lock assembly 60 may be depressed with enough force to overcome the repelling force of the strut 160 allowing the lock assembly 60 to recede into the opening 26 in the main portion 24 to substantially clear the lock assembly 60 from the path of the foldable knife 92. The foldable knife 92 can then be removed from the sheath 6.

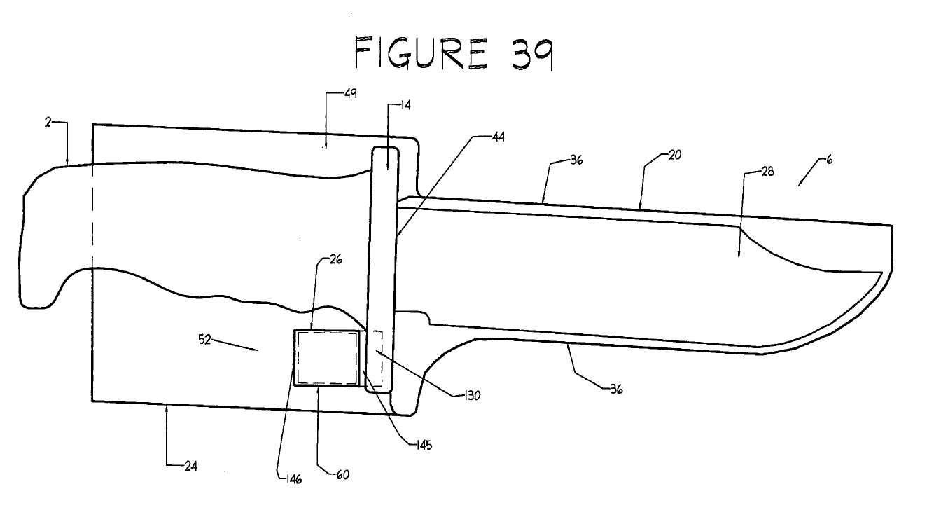

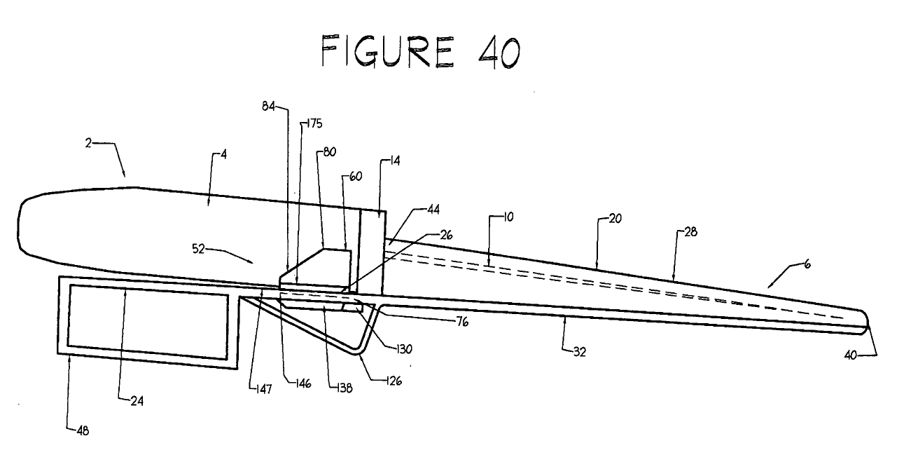

FIGS. 39 and 40 illustrate a tenth exemplary embodiment of the locking mechanism 52. For brevity, detailed descriptions of the knife and sheath will not be repeated. The locking mechanism 52 of FIGS. 39 and 40 may include metal plate 175, assembly magnet 138, and a lock assembly 60. In this exemplary embodiment a recessed main portion 126 is formed at the back side 32 of the main portion 24, for example, between the belt loop 48 and the upper end 44 of the knife receptacle 20 as illustrated in FIG. 40. A metal plate 175 may be attached to the main portion 24 and can be substantially located between the recessed main portion 126 and the lock assembly 60. An assembly magnet 138 can be attached to the first assembly end 76 of the lock assembly 60 and can be substantially located between the metal plate 175 and the recessed main portion. The assembly magnet 138 may be positioned to be substantially attracted to the metal plate 175. The recessed main portion 126 can be spaced a distance away from the back side 32 of the main portion 24 to allow both the lock assembly 60 and the assembly magnet 138 to pass through the opening 26 in the main portion 24. The size of the opening 26 in the main portion 24 can be substantially large enough to allow the lock assembly 60 to pass through the main portion 24, but may not allow a flange 130, which can be connected to the first assembly end 76 of the lock assembly 60, to pass through the opening 26 of the main portion 24. The first assembly end 76 may be substantially opposed to the flange 130 of the lock assembly 60 and can be attached to the main portion by any means known in the art. For example, the assembly end 76 opposed to the flange 130 may be attached to a first hinge end 145 of a hinge 146 for allowing the lock assembly 60 to substantially pivot around the hinge 146. Distal to the first hinge end 145 is a second hinge end 147 for workably attaching the hinge 146 to the main portion 24.

FIG. 40 provides a side view of the locking mechanism 52 according to the tenth exemplary embodiment. The lock assembly 60 may have a substantially cube like shape having a first assembly end 76 attached to both, the flange 130 and opposed to the flange 130, a hinge 146. The lock assembly 60 may also have a second assembly end 80 protruding through the back side 32 of the main portion 24 and over the hilt 14 of the fixed blade knife 2. The cubical corner of the second assembly end 80 that is furthest away from the knife receptacle 20 can be rounded to create a rounded corner 84, as illustrated in FIG. 24. The lock assembly 60 may substantially encase the assembly magnet 138 and the metal plate 175 as illustrated in FIG. 40. For example, the lock assembly 60 may be hollow to receive the end of the assembly magnet 138 and the metal plate 175. The assembly magnet 138 along with the second assembly end 80 of the lock assembly 60 may substantially protrude over the hilt 14 of the fixed blade knife 2 while the flange 130 remains on the back side 32 of the sheath 6. As one of skill in the art will appreciate, the shape of the lock assembly may be any shape consistent with the teaching of this disclosure.

According to the tenth exemplary embodiment, when the blade 10 of the fixed blade knife 2 is inserted into the knife receptacle 20, the fixed blade knife 2 is substantially automatically locked to the sheath 6 by the locking mechanism 52. The rounded corner 84 of the lock assembly 60 will allow the hilt 14 and blade 10 to more easily pass over the lock assembly 60 with little resistance when the fixed blade knife 2 is inserted into the knife receptacle 20. As the hilt 14 or blade 10 passes over the lock assembly 60, the lock assembly 60 is depressed with minimal resistance, from the attracting force between the assembly magnet 138 and the metal plate 175, through the opening 26 in the main portion 24 and substantially towards the recessed main portion 126. Once the hilt 14 passes over the lock assembly 60, the assembly magnet 138 of the lock assembly 60 is attracted back to the metal plate 175 returning the second assembly end 80 to its resting position through the opening 26 in the main portion 24 and back over and above the hilt 14, thus substantially and automatically securing the fixed blade knife 2 to the sheath 6. The flange 130 substantially pressing against the back side 32 of the main portion 24 while the lock assembly is in its resting position. A resting position of the lock assembly 60 is illustrated in FIGS. 39 and 40. In addition to the automatic securing of the knife, the user of the fixed blade knife 2 may also depress the lock assembly 60 through the opening 26 in the main portion 24 to allow the hilt 14 to pass over the lock assembly 60. The user may then release the lock assembly 60 to lock the fixed blade knife 2 to the sheath 6. In the lock assembly's resting position, the hilt 14 is substantially secured between the lock assembly 60 and the upper end 44 of the knife receptacle 20 to substantially secure the fixed blade knife 2 to the sheath 6.

When removing the fixed blade knife 2 from the receptacle 20, the second assembly end 80 of the lock assembly 60 may first clear the hilt's 14 path. To clear the hilt's 14 path, the lock assembly 60 may be depressed through the opening 26 in the main portion 24 clearing the path of the hilt 14 before pulling the blade 10 from the knife receptacle 20. If the lock assembly 60 is not depressed before trying to remove the fixed blade knife 2 from the knife receptacle 20, the hilt 14 will make contact with the lock assembly 60. This contact will substantially prevent the removal of the fixed blade knife 2. More specifically, when the fixed blade knife 2 is pulled toward the lock assembly 60, downward forces are created by the lock assembly 60 to substantially prevent the hilt 14 from bypassing the lock assembly 60 by mere pulling on the fixed blade knife 2.

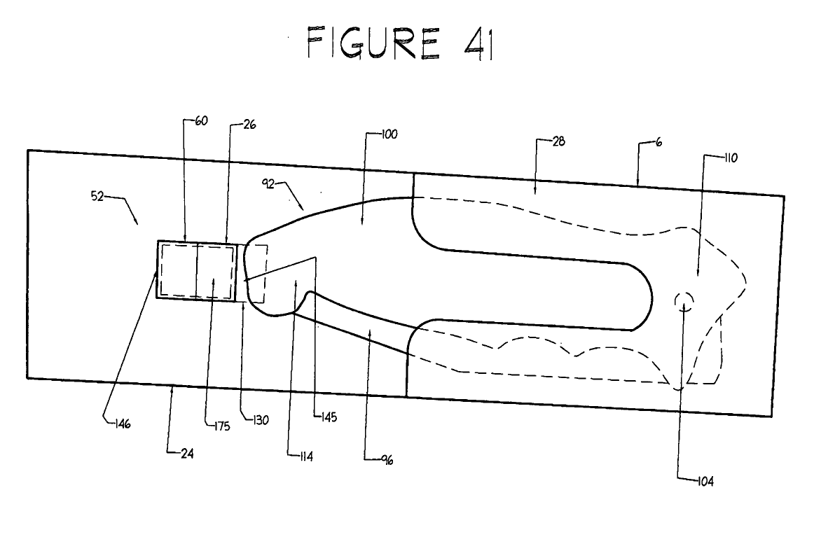

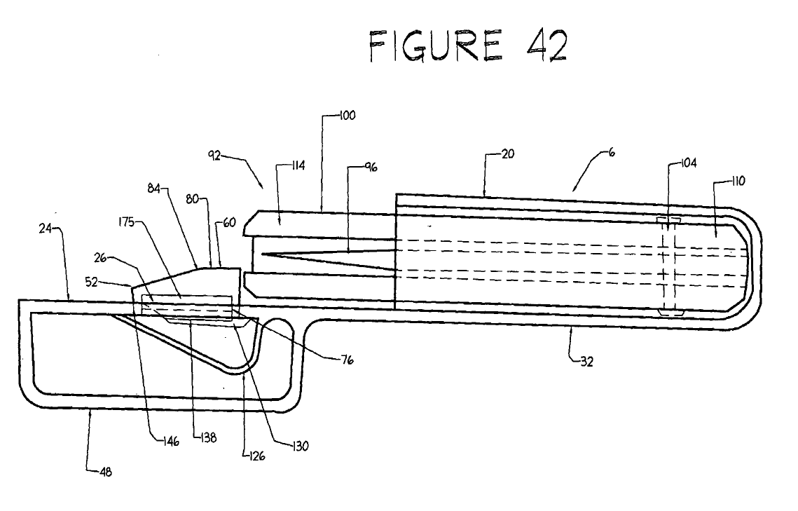

FIGS. 41 and 42 further illustrate the tenth exemplary embodiment wherein the embodiment is being used in conjunction with a foldable knife 92. In this example, to secure the foldable knife 92 within the sheath 6, the foldable knife 92 is first folded. Next, the foldable knife 92 is inserted into the knife receptacle 20. To insert the foldable knife 92 into the knife receptacle 20 the user may substantially depress the lock assembly 60 with substantially enough force to overcome the attracting force between the assembly magnet 138 and the metal plate 175. The lock assembly 60 may then substantially pivot around the hinge 146 and into the opening 26 in the main portion 24 towards the recessed main portion 126 to allow the foldable knife 92 to enter into the knife receptacle 20 with substantially minimal obstruction from the lock assembly 60. After the foldable knife 92 is substantially located within the knife receptacle 20 and the lock assembly 60 is no longer depressed with enough force to overcome the attracting force between the magnets, the lock assembly 60 can substantially pivot around the hinge 146 towards the front side 49 of the main portion 60 until the flange 130 substantially makes contact with the back side 32 of the knife sheath 6. With the flange 130 substantially making contact with the back side 32, the second assembly end 80 of the lock assembly 60 can substantially protrude over the foldable knife 92 to substantially secure the knife within the knife sheath 6. To remove the foldable knife 92 from the sheath 6, the lock assembly 60 may be depressed with enough force to overcome the attracting force of the magnet allowing the lock assembly 60 to recede into the opening 26 in the main portion 24 to substantially clear the lock assembly 60 from the path of the foldable knife 92. The foldable knife 92 can then be removed from the sheath 6.

The present invention is designed to reduce dirt, grit, twigs, ice, and other elements from catching or building up in and around the locking assembly, and from interfering with the locking assembly. As a result these benefits will increase the locking assembly's reliability and help prevent the unwanted escaping of the knife from its sheath. This will allow the knife to be stored more easily and help prevent unwanted cutting when storing and removing the knife from its sheath.

To increase the locking assembly's ability to work under harsh elements, the disclosed locking assembly may be easily operated with one hand and has a no-look locking and unlocking operation. Again, this will allow the knife to be stored more easily and help prevent unwanted cutting when storing and removing the knife from its sheath.

Also, the present locking assembly will not easily be bypassed by excessive force. The present locking assembly is designed to exert a greater force to hold the knife within the sheath as greater and greater force is applied to pull the knife from its sheath without disengaging the locking assembly. Therefore, the present invention will work to prevent the bypassing of the lock assembly by excessive force.

In addition, the present invention will work with multiple fixed blade knives and folding knives including but not limiting to knives with finger guards or other protrusions extending from the knife. Additionally, the present invention will also work with multiple fixed blade knives without a hilt. The present invention will also work with multiple knives for a single locking assembly and sheath. With the present invention versatile locking mechanism the customer is not forced to buy a specific knife for only one matching sheath therefore reducing the costs associated with securing a knife with a sheath.

Moreover, the present invention's locking assembly is a very simple design with minimal elements making the locking assembly very inexpensive to manufacture as well. The simple design of the locking assembly is also considered aesthetically pleasing as the only visible part of the system is the button which can be configured in any manner to compliment the design-look of the knife and sheath.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A locking mechanism for securing a knife to a sheath, the locking mechanism comprising:
a lock assembly, and
a spring attached to the lock assembly,
wherein when the knife is inserted into the sheath, the lock assembly secures the knife; and
wherein the spring has a first spring area distal a second spring area, the second spring area adjacent the lock assembly, and the first spring area adjacent the sheath.

2. A sheath for use with a knife, comprising:
a main portion,
a receptacle extending from the main portion,
a lock assembly spaced from an opening of the receptacle,
a spring operably connecting the lock assembly to the main portion,
wherein the spring has a first spring area and a second spring area,
the first spring area operably connected to the sheath, and
the second spring area adjacent the lock assembly; and
wherein the lock assembly is capable of engaging a portion of the knife.

3. The sheath as claimed in claim 2, wherein the knife is a foldable knife and the lock assembly is capable of extending over the foldable knife in a folded position to substantially secure the foldable knife in the sheath.

4. A sheath for use with a knife, comprising:
a main portion having a front side and a back side,
a receptacle area extending from the main portion,
an opening through the main portion extending between the front side and the back side,
a lock assembly spaced from an opening of the receptacle,
the lock assembly having a first end workably attached to the main portion,
the lock assembly having a second end engagable to the opening in the main portion,
a flange attached to the first end of the lock assembly,
the back side substantially preventing the flange from engaging the opening in the main portion,
an assembly magnet adjacent to the lock assembly, and
a recessed sheath portion attached to the backside of the main portion.

5. The sheath as claimed in claim 4, wherein the recessed sheath portion is adjacent a recessed main portion magnet.

6. The sheath as claimed in claim 5, wherein the assembly magnet has a polarity the same as the recessed main portion magnet.

7. The sheath portion as claimed in claim 5, wherein the recessed sheath portion is for substantially receiving the lock assembly and assembly magnet.

8. The sheath as claimed in claim 4, wherein a metal plate is adjacent the opening through the main portion.

9. A locking mechanism for securing a knife to a sheath, the locking mechanism comprising:
a lock assembly, and
a strut attached to the lock assembly,
wherein when the knife is inserted into the sheath, the lock assembly secures the knife; and
wherein the strut has a first strut area distal a second strut area, the second strut area adjacent the lock assembly, and the first strut area adjacent the sheath.
